(19) United States
(12) Patent Application Publication
(10) Pub. No.: US 2022/0186643 A1
(43) Pub. Date: Jun. 16, 2022

(54) EXHAUST PURIFICATION SYSTEM OF INTERNAL COMBUSTION ENGINE

(71) Applicant: TOYOTA JIDOSHA KABUSHIKI KAISHA, Aichi-ken (JP)

(72) Inventors: Takahiro TSUKAGOSHI, Susono-shi (JP); Noriyasu KOBASHI, Hachioji-shi (JP); Takahiko FUJIWARA, Shizuoka-ken (JP); Teruaki HAIBARA, Kanagawa-ken (JP); Taku MIURA, Susono-shi (JP)

(21) Appl. No.: 17/547,230

(22) Filed: Dec. 10, 2021

(30) Foreign Application Priority Data
Dec. 14, 2020 (JP) 2020-206986

(51) Int. Cl. F01N 3/023; F01N 3/10; F01N 11/00; F02D 41/02; F02D 41/14

(52) U.S. Cl. CPC F01N 3/023; F01N 3/101; F02D 41/1454; F02D 41/0235; F01N 11/002

(57) ABSTRACT

The exhaust purification system of an internal combustion engine includes a filter trapping particulate matter in exhaust gas flowing through an exhaust passage of the internal combustion engine and supporting a three-way catalyst, and a filter regeneration part configured to perform regeneration processing for oxidizing and removing particulate matter deposited on the filter when predetermined conditions are satisfied. The filter regeneration part is configured to increase an NO concentration in exhaust gas flowing into the filter when the predetermined conditions are satisfied compared to when the predetermined conditions are not satisfied.

### FIELD

The present disclosure relates to an exhaust purification system of an internal combustion engine.

### BACKGROUND

In the past, it has been known to provide an exhaust passage of an internal combustion engine with a filter for trapping particulate matter (PM) in exhaust gas. If a large amount of PM is deposited on such a filter, the filter clogs and back pressure increases whereby reduced output by the internal combustion engine, fuel economy deterioration, etc. are liable to occur. Therefore, it is necessary to remove PM from the filter before the amount of PM deposited on the filter becomes too large.

Regarding this, PTL 1 describes that in a diesel engine, by supplying NO₂ with its high oxidizing power to a filter (DPF), it is possible to oxidize and remove PM even in a low temperature region where burning of PM by oxygen is not promoted.

Further, in recent years, to further improve exhaust emissions, in internal combustion engines such as gasoline engines, it has been studied to provide a filter for trapping PM in an exhaust passage in addition to a three-way catalyst. In such internal combustion engines, the PM on the filter will react with oxygen and burn off when fuel cut control for stopping the supply of fuel to the combustion chambers is performed.

### CITATIONS LIST

### Patent Literature

[PTL 1] Japanese Unexamined Patent Publication No. 2002-285823

### SUMMARY

### Technical Problem

However, if there are few opportunities for fuel cut control to be performed, the amount of PM deposited on the filter will gradually increase, making the filter liable to clog. Therefore, it is desirable to remove PM on the filter even at timings other than that of fuel cut control.

However, to remove PM by supplying NO₂ to the filter, the air-fuel ratio of the air-fuel mixture must be made an excessively lean value. If such air-fuel ratio control is performed in internal combustion engines such as gasoline engines, the exhaust purifying ability of the three-way catalyst will drop and exhaust emissions will worsen. Accordingly, in internal combustion engines that purify exhaust gas mainly in three-way catalysts, removing PM by supplying NO₂ to the filter like in PTL 1 is difficult.

Therefore, considering this problem, an object of the present disclosure is to keep an amount of PM deposited on a filter from becoming excessive in an internal combustion engine having an exhaust passage provided with a three-way catalyst and a filter.

### Solution to Problem

The summary of the present disclosure is as follows.

(1) An exhaust purification system of an internal combustion engine, comprising: a filter trapping particulate matter in exhaust gas flowing through an exhaust passage of the internal combustion engine and supporting a three-way catalyst; and a filter regeneration part configured to perform regeneration processing for oxidizing and removing particulate matter deposited on the filter when predetermined conditions are satisfied, wherein the filter regeneration part is configured to increase an NO concentration in exhaust gas flowing into the filter when the predetermined conditions are satisfied compared to when the predetermined conditions are not satisfied.

(2) The exhaust purification system of an internal combustion engine described in above (1), further comprising: a temperature calculating part configured to calculate a temperature of the three-way catalyst, wherein the predetermined conditions include that the temperature of the three-way catalyst be within a predetermined range.

(3) The exhaust purification system of an internal combustion engine described in above (1) or (2), further comprising: a deterioration estimating part configured to calculate a degree of deterioration of the three-way catalyst, wherein the predetermined conditions include that the degree of deterioration of the three-way catalyst be equal to or greater than a predetermined value.

(4) The exhaust purification system of an internal combustion engine described in any one of above (1) to (3), wherein the filter regeneration part is configured to control an air-fuel ratio of an air-fuel mixture supplied to combustion chambers of the internal combustion engine to a target air-fuel ratio, and set the target air-fuel ratio to a value leaner than a stoichiometric air-fuel ratio when the predetermined conditions are satisfied.

(5) The exhaust purification system of an internal combustion engine described in any one of above (1) to (3), wherein the filter regeneration part is configured to increase a combustion temperature of an air-fuel mixture supplied to the combustion chambers of the internal combustion engine when the predetermined conditions are satisfied compared to when the predetermined conditions are not satisfied.

(6) The exhaust purification system of an internal combustion engine described in above any one of (1) to (5), further comprising: a deterioration estimating part configured to calculate a degree of deterioration of the three-way catalyst, wherein the filter regeneration part is configured to increase the NO concentration in the exhaust gas flowing into the filter when performing the regeneration processing as the degree of deterioration of the three-way catalyst increases.

(7) The exhaust purification system of an internal combustion engine described in any one of above (1) to (5), further comprising: an ash calculating part configured to calculate an amount of ash deposited on the filter, wherein the filter regeneration part is configured to increase the NO concentration in the exhaust gas flowing into the filter when performing the regeneration processing as the amount of ash deposited increases.

(8) The exhaust purification system of an internal combustion engine described in any one of above (1) to (5), further comprising: a deterioration estimating part configured to calculate a degree of deterioration of the three-way catalyst; and an ash calculating part configured to calculate an amount of ash deposited on the filter, wherein the filter regeneration part is configured to determine the NO concentration in the exhaust gas flowing into the filter when performing the regeneration processing based on the degree of deterioration of the three-way catalyst and the amount of ash deposited.

(9) The exhaust purification system of an internal combustion engine described in any one of above (1) to (5), further comprising: a PM calculating part configured to calculate an amount of particulate matter deposited on the filter; and a deterioration estimating part configured to calculate a degree of deterioration of the three-way catalyst, wherein the filter regeneration part is configured to start the regeneration processing when the amount of particulate matter deposited is equal to or greater than a predetermined starting threshold and end the regeneration processing when the amount of particulate matter deposited is equal to or less than a predetermined ending threshold, and the PM calculating part is configured to calculate an amount of particulate matter oxidized and removed per unit time by the regeneration processing and output an amount of particulate matter that is smaller the larger the degree of deterioration of the three-way catalyst.

(10) The exhaust purification system of an internal combustion engine described in any one of above (1) to (5), further comprising: a PM calculating part configured to calculate an amount of particulate matter deposited on the filter; and an ash calculating part configured to calculate an amount of ash deposited on the filter, wherein the filter regeneration part is configured to start the regeneration processing when the amount of particulate matter deposited is equal to or greater than a predetermined starting threshold and end the regeneration processing when the amount of particulate matter deposited is equal to or less than a predetermined ending threshold, and the PM calculating part is configured to calculate an amount of particulate matter oxidized and removed per unit time by the regeneration processing and output an amount of particulate matter that is smaller the larger the amount of ash deposited.

(11) The exhaust purification system of an internal combustion engine described in any one of above (1) to (5), further comprising: a PM calculating part configured to calculate an amount of particulate matter deposited on the filter; a deterioration estimating part configured to calculate a degree of deterioration of the three-way catalyst; and an ash calculating part configured to calculate an amount of ash deposited on the filter, wherein the filter regeneration part is configured to start the regeneration processing when the amount of particulate matter deposited is equal to or greater than a predetermined starting threshold and end the regeneration processing when the amount of particulate matter deposited is equal to or less than a predetermined ending threshold, and the PM calculating part is configured to calculate an amount of particulate matter oxidized and removed per unit time by the regeneration processing based on the degree of deterioration of the three-way catalyst and amount of deposited ash.

(12) The exhaust purification system of an internal combustion engine described in any one of above (1) to (11), further comprising: a PM calculating part configured to calculate an amount of particulate matter deposited on the filter, wherein the PM calculating part is configured to calculate the amount of particulate matter deposited based on a NOx concentration or a CO concentration in exhaust gas flowing out from the filter when the regeneration processing is being performed.

(13) The exhaust purification system of an internal combustion engine described in any one of above (1) to (11), further comprising: a PM calculating part configured to calculate an amount of particulate matter deposited on the filter, wherein the PM calculating part is configured to calculate the amount of particulate matter deposited based on a NOx concentration or a CO concentration in exhaust gas flowing into the filter when the regeneration processing is being performed.

(14) The exhaust purification system of an internal combustion engine described in any one of above (1) to (13), further comprising: a deterioration estimating part configured to calculate a degree of deterioration of the three-way catalyst, wherein the deterioration estimating part is configured to calculate the degree of deterioration of the three-way catalyst based on a NOx concentration in exhaust gas flowing into the filter when the regeneration processing is being performed and a NOx concentration in exhaust gas flowing out from the filter when the regeneration processing is being performed.

(15) The exhaust purification system of an internal combustion engine described in any one of above (1) to (13), further comprising: a deterioration estimating part configured to calculate a degree of deterioration of the three-way catalyst, wherein the deterioration estimating part is configured to calculate the degree of deterioration of the three-way catalyst based on a CO concentration in exhaust gas flowing into the filter when the regeneration processing is being performed and a CO concentration in exhaust gas flowing out from the filter when the regeneration processing is being performed.

(16) An exhaust purification system of an internal combustion engine, comprising: a filter trapping particulate matter in exhaust gas flowing through an exhaust passage of the internal combustion engine and supporting a three-way catalyst; a filter regeneration part configured to perform regeneration processing for oxidizing and removing particulate matter deposited on the filter; and a PM calculating part configured to calculate an amount of particulate matter deposited on the filter, wherein the filter regeneration part is configured to perform the regeneration processing by supplying NO to the filter, and the PM calculating part is configured to calculate the amount of particulate matter deposited based on a NOx concentration or a CO concentration in exhaust gas flowing into the filter when the regeneration processing is being performed or a NOx concentration or a CO concentration in exhaust gas flowing out from the filter when the regeneration processing is being performed.

(17) An exhaust purification system of an internal combustion engine, comprising: a filter trapping particulate matter in exhaust gas flowing through an exhaust passage of the internal combustion engine and supporting a three-way catalyst; a filter regeneration part configured to perform regeneration processing for oxidizing and removing particulate matter deposited on the filter; and a deterioration estimating part configured to calculate a degree of deterioration of the three-way catalyst, wherein the filter regeneration part is configured to perform the regeneration processing by supplying NO to the filter, and the deterioration estimating part is configured to calculate the degree of deterioration of the three-way catalyst based on both a NOx concentration in exhaust gas flowing into the filter when the regeneration processing is being performed and a NOx concentration in exhaust gas flowing out from the filter when the regeneration processing is being performed or both a CO concentration in exhaust gas flowing into the filter when the regeneration processing is being performed and a CO concentration in exhaust gas flowing out from the filter when the regeneration processing is being performed.

According to the present disclosure, it is possible to keep an amount of PM deposited on a filter from becoming excessive in an internal combustion engine having an exhaust passage provided with a three-way catalyst and a filter.

### BRIEF DESCRIPTION OF DRAWINGS

FIG. 1 is a view schematically showing an internal combustion engine in which an exhaust purification system of an internal combustion engine according to a first embodiment of the present disclosure is provided.

FIG. 2 is a view showing an example of purification characteristics of a three-way catalyst.

FIG. 3 is a functional block diagram of an ECU in the first embodiment.

FIG. 4 is a view showing an example of change over time in the concentrations of NO, CO, and CO₂ in the exhaust gas flowing out from a filter when NO is supplied to the filter.

FIG. 5 is a flow chart showing a control routine for the regeneration processing in the first embodiment of the present disclosure.

FIG. 6 is a view showing a regeneration processing region defined by the temperature and the degree of deterioration of the three-way catalyst on the filter.

FIG. 7 is a view schematically showing an internal combustion engine in which an exhaust purification system of an internal combustion engine according to a second embodiment of the present disclosure is provided.

FIG. 8 is a view showing relationships between a combustion temperature of an air-fuel mixture and the concentration of NO and concentration of CO in exhaust gas.

FIG. 9 is a flow chart showing a control routine for the regeneration processing in a third embodiment of the present disclosure.

FIG. 10 is a view showing a relationship between the degree of deterioration of the three-way catalyst and the target air-fuel ratio of an air-fuel mixture.

FIG. 11 is a view showing a relationship between the degree of deterioration of the three-way catalyst and the amount of PM removed.

FIG. 12 is a block diagram of the ECU in a fifth embodiment.

FIG. 13 is a view showing a relationship between the amount of ash deposited and the target air-fuel ratio of the air-fuel mixture.

FIG. 14 is a view showing a relationship between the amount of ash deposited and the amount of PM removed.

FIG. 15 is a view showing a map for calculating the target air-fuel ratio of the air-fuel mixture based on the degree of deterioration of the three-way catalyst and the deposited amount of ash.

FIG. 16 is a view showing a map for calculating the amount of PM removed based on the degree of deterioration of the three-way catalyst and the amount of ash deposited.

FIG. 17 is a view schematically showing an internal combustion engine in which an exhaust purification system of an internal combustion engine according to a ninth embodiment of the present disclosure is provided.

FIG. 18 is a view showing a relationship between the concentration of CO and concentration of NOx in the outflowing exhaust gas and the amount of PM deposited.

FIG. 19 is a view schematically showing an internal combustion engine in which an exhaust purification system of an internal combustion engine according to an 11th embodiment of the present disclosure is provided.

FIG. 20 is a view showing a relationship between the concentration of CO and concentration of NOx in the inflowing exhaust gas and the amount of PM deposited.

FIG. 21 is a view showing a relationship between the concentration of CO and concentration of NOx in the inflowing exhaust gas and the amount of PM removed.

FIG. 22 is a view schematically showing an internal combustion engine in which an exhaust purification system of an internal combustion engine according to a 13th embodiment of the present disclosure is provided.

FIG. 23 is a view showing the relationships between the differences in the concentrations of NOx and the concentrations of CO before and after the filter and the degree of deterioration of the three-way catalyst.

FIG. 24 is a flow chart showing a control routine for deterioration estimation processing in the 13th embodiment of the present disclosure.

FIG. 25 is a flow chart showing a control routine for deterioration estimation processing in a 14th embodiment of the present disclosure.

### DESCRIPTION OF EMBODIMENTS

Below, referring to the drawings, embodiments of the present disclosure will be explained in detail. Note that, in the following explanation, similar component elements are assigned the same reference numerals.

### First Embodiment

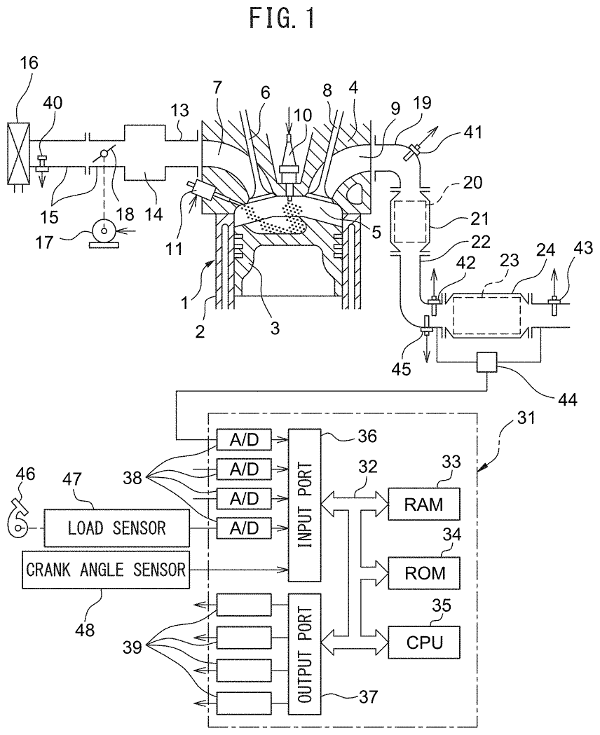

First, referring to FIG. 1 to FIG. 6, a first embodiment of the present disclosure will be explained.

<Explanation of Internal Combustion Engine as a Whole>

FIG. 1 is a view schematically showing an internal combustion engine provided with an exhaust purification system of an internal combustion engine according to the first embodiment of the present disclosure. The internal combustion engine as shown in FIG. 1 is a spark ignition type internal combustion engine, specifically, a gasoline engine fueled by gasoline. The internal combustion engine is mounted in a vehicle.

The internal combustion engine is provided with an engine body 1 including a cylinder block 2 and a cylinder head 4. Inside the cylinder block 2, a plurality of (for example, four) cylinders are formed. In the cylinders, pistons 3 reciprocating in the axial directions of the cylinders are arranged. Between the pistons 3 and cylinder head 4, combustion chambers 5 are formed.

The cylinder head 4 is formed with intake ports 7 and exhaust ports 9. The intake ports 7 and exhaust ports 9 are connected to the combustion chambers 5.

Further, the internal combustion engine is provided with intake valves 6 and exhaust valves 8 arranged in the cylinder head 4. The intake valves 6 open and close the intake ports 7, while the exhaust valves 8 open and close the exhaust ports 9.

Further, the internal combustion engine is provided with spark plugs 10 and fuel injectors 11. The spark plugs 10 are arranged at the center parts of the inside wall surfaces of the cylinder head 4 and generate sparks in response to ignition signals. The fuel injectors 11 are arranged at the peripheral parts of the inside wall surfaces of the cylinder head 4 and inject fuel into the combustion chambers 5 in response to injection signals. In the present embodiment, as the fuel stored in the vehicle and supplied to the fuel injectors 11, gasoline with a stoichiometric air-fuel ratio of 14.6 is used.

Further, the internal combustion engine is provided with intake runners 13, a surge tank 14, an intake pipe 15, an air cleaner 16, and a throttle valve 18. The intake ports 7 of the cylinders are respectively connected through corresponding intake runners 13 to the surge tank 14. The surge tank 14 is connected through the intake pipe 15 to the air cleaner 16. The intake ports 7, the intake runners 13, the surge tank 14, the intake pipe 15, etc., form an intake passage guiding air to the combustion chambers 5. The throttle valve 18 is arranged inside the intake pipe 15 between the surge tank 14 and the air cleaner 16 and is driven by a throttle valve drive actuator 17 (for example, DC motor). The throttle valve 18 is made to turn by the throttle valve drive actuator 17, whereby it is possible to change the open area of the intake passage corresponding to the opening degree.

Further, the internal combustion engine is provided with an exhaust manifold 19, an exhaust pipe 22, a catalyst 20, and a filter 23. The exhaust ports 9 of the cylinders are connected to the exhaust manifold 19. The exhaust manifold 19 has a plurality of branch parts connected to the exhaust ports 9 and a plenum where these branch parts are collected. The plenum of the exhaust manifold 19 is connected to an upstream side casing 21 having the catalyst 20 built into it. The upstream side casing 21 is connected through the exhaust pipe 22 to a downstream side casing 24 having the filter 23 built into it. The exhaust ports 9, the exhaust manifold 19, the upstream side casing 21, the exhaust pipe 22, the downstream side casing 24, etc., form an exhaust passage discharging exhaust gas generated by combustion of the air-fuel mixture in the combustion chambers 5.

Further, the vehicle provided with the internal combustion engine is provided with an electronic control unit (ECU). As shown in FIG. 1, the ECU 31 is comprised of a digital computer provided with components connected with each other through bidirectional buses 32 such as a RAM (random access memory) 33, a ROM (read only memory) 34, a CPU (microprocessor) 35, input ports 36, and output ports 37.

The ECU 31 performs various control operations of the internal combustion engine based on the outputs of various types of sensors provided at the vehicle or the internal combustion engine, etc. That is, the ECU 31 functions as a control device of the internal combustion engine.

Therefore, the outputs of various types of sensors are input to the ECU 31. In the present embodiment, outputs of an air flow meter 40, a first air-fuel ratio sensor 41, a second air-fuel ratio sensor 42, a third air-fuel ratio sensor 43, a differential pressure sensor 44, a temperature sensor 45, a load sensor 47, and a crank angle sensor 48 are input to the ECU 31.

The air flow meter 40 is arranged in the intake passage, specifically inside the intake pipe 15 at the upstream side from the throttle valve 18. The air flow meter 40 detects the amount of flow of the air flowing through the intake passage. The air flow meter 40 is electrically connected to the ECU 31. The output of the air flow meter 40 is input through a corresponding AD converter 38 to the input port 36.

The first air-fuel ratio sensor 41 is arranged in the exhaust passage at the upstream side from the filter 23 and the catalyst 20, specifically at the plenum of the exhaust manifold 19. The first air-fuel ratio sensor 41 detects the air-fuel ratio of exhaust gas discharged from the cylinders of the internal combustion engine and flowing into the catalyst 20. The first air-fuel ratio sensor 41 is electrically connected to the ECU 31, and the output of the first air-fuel ratio sensor 41 is input through a corresponding AD converter 38 to the input port 36.

The second air-fuel ratio sensor 42 is arranged in the exhaust passage at the downstream side from the catalyst 20 and the upstream side from the filter 23, specifically inside the exhaust pipe 22 between the catalyst 20 and the filter 23. The second air-fuel ratio sensor 42 detects the air-fuel ratio of exhaust gas flowing out from the catalyst 20 and flowing into the filter 23. The second air-fuel ratio sensor 42 is electrically connected to the ECU 31, and the output of the second air-fuel ratio sensor 42 is input through a corresponding AD converter 38 to the input port 36.

The third air-fuel ratio sensor 43 is arranged in the exhaust passage at the downstream side from the filter 23, specifically inside the exhaust pipe 22 at the downstream side from the filter 23. The third air-fuel ratio sensor 43 detects the air-fuel ratio of exhaust gas flowing out from the filter 23. The third air-fuel ratio sensor 43 is electrically connected to the ECU 31, and the output of the third air-fuel ratio sensor 43 is input through a corresponding AD converter 38 to the input port 36.

The differential pressure sensor 44 is arranged in the exhaust passage so as to detect a difference between a pressure in the exhaust passage at the upstream side from the filter 23 and a pressure in the exhaust passage at the downstream side from the filter 23, that is, the differential pressure before and after the filter 23. The differential pressure sensor 44 is electrically connected to the ECU 31. The output of the differential pressure sensor 44 is input through a corresponding AD converter 38 to the input port 36.

The temperature sensor 45 is arranged in the exhaust passage at the upstream side from the filter 23, specifically, in the exhaust pipe 22 between the catalyst 20 and the filter 23. The temperature sensor 45 detects the temperature of the exhaust gas flowing into the filter 23. The temperature sensor 45 is electrically connected to the ECU 31. The output of the temperature sensor 45 is input through a corresponding AD converter 38 to the input port 36.

The load sensor 47 is connected to an accelerator pedal 46 provided at the vehicle mounting the internal combustion engine and detects the amount of depression of the accelerator pedal 46. The load sensor 47 is electrically connected to the ECU 31. The output of the load sensor 47 is input through a corresponding AD converter 38 to the input port 36. The ECU 31 calculates the engine load based on the output of the load sensor 47.

The crank angle sensor 48 generates an output pulse each time a crankshaft of the internal combustion engine rotates by a predetermined angle (for example, 10 degrees). The crank angle sensor 48 is electrically connected to the ECU 31. The output of the crank angle sensor 48 is input to the input port 36. The ECU 31 calculates the engine speed based on the output of the crank angle sensor 48.

On the other hand, the output ports 37 of the ECU 31 are connected through corresponding drive circuits 39 to the spark plugs 10, the fuel injectors 11, and the throttle valve drive actuator 17. The ECU 31 controls these. Specifically, the ECU 31 controls the ignition timings of the spark plugs 10, the injection timings and injection amounts of the fuel injected from the fuel injectors 11, and the opening degree of the throttle valve 18.

Note that although the above-mentioned internal combustion engine is a naturally aspirated internal combustion engine fueled by gasoline, the configuration of the internal combustion engine is not limited to the above configuration. Accordingly, the specific configuration of the internal combustion engine such as the cylinder array, injection mode of fuel, configuration of the intake/exhaust system, configuration of the valve operating mechanism, and the presence of a supercharger may be different from the configuration shown in FIG. 1.

<Exhaust Purification System of Internal Combustion Engine>

Below, an exhaust purification system of an internal combustion engine (below, simply referred to as “exhaust purification system”) according to a first embodiment of the present disclosure will be explained. The exhaust purification system is provided with a catalyst 20, a filter 23, and an ECU 31. As shown in FIG. 1, in the exhaust flow direction, the catalyst 20 is arranged in the exhaust passage at the upstream side from the filter 23, and the filter 23 is arranged in the exhaust passage at the downstream side from the catalyst 20.

The catalyst 20 is a configured to purify exhaust gas flowing in the exhaust passage of the internal combustion engine and is, for example, a three-way catalyst which can simultaneously remove hydrocarbons (HC), carbon monoxide (CO), and nitrogen oxides (NOx). In this case, the catalyst 20 comprises a support (substrate) formed from ceramic or metal, a noble metal having a catalytic action (for example, platinum (Pt), palladium (Pd), rhodium (Rh), etc.), and a promoter having an oxygen storage ability (for example, ceria (CeO₂) etc.). The noble metal and the promoter are supported on the support.

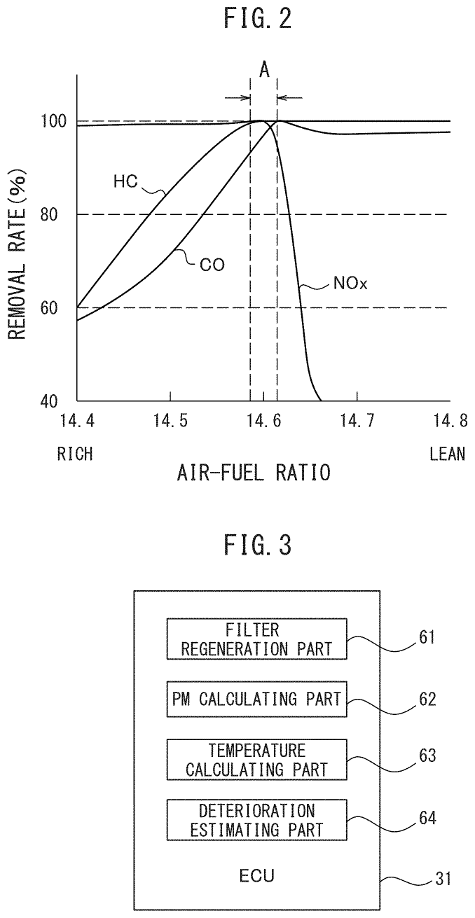

FIG. 2 is a view showing an example of purification characteristics of the three-way catalyst. As shown in FIG. 2, the rates of removal of HC, CO, and NOx by the three-way catalyst become extremely high when the air-fuel ratio of the exhaust gas flowing into the three-way catalyst is in a region in the neighborhood of the stoichiometric air-fuel ratio (purification window A in FIG. 2). Accordingly, when the air-fuel ratio of exhaust gas is kept in the neighborhood of the stoichiometric air-fuel ratio, the three-way catalyst can effectively remove HC, CO, and NOx.

The filter 23 traps particulate matter (PM) in the exhaust gas flowing through the exhaust passage of the internal combustion engine and is formed from, for example, porous ceramic. In the present embodiment, the three-way catalyst is supported on the filter 23. The three-way catalyst supported on the filter 23 (below, also referred to as the “three-way catalyst on the filter 23”) has a similar configuration to the catalyst 20 and functions similarly to the catalyst 20. Accordingly, the filter 23 has, in addition to the PM trapping function of porous ceramic, the function of exhaust purification by the three-way catalyst. That is, the filter 23 is a so-called four-way catalyst. Note that the filter 23 is also referred to as a gasoline particulate filter (GPF).

FIG. 3 is a functional block diagram of the ECU 31 in the first embodiment. In the present embodiment, the ECU 31 has a filter regeneration part 61, a PM calculating part 62, a temperature calculating part 63, and a deterioration estimating part 64. The filter regeneration part 61, the PM calculating part 62, the temperature calculating part 63, and the deterioration estimating part 64 are functional modules realized by the CPU 35 of the ECU 31 running programs stored in the ROM 34 of the ECU 31.

The filter regeneration part 61 performs regeneration processing for oxidizing and removing PM deposited on the filter 23. The PM calculating part 62 calculates the amount of PM deposited on the filter 23. The temperature calculating part 63 calculates the temperature of the three-way catalyst on the filter 23. The deterioration estimating part 64 calculates the degree of deterioration of the three-way catalyst on the filter 23.

When PM-containing exhaust gas generated by combustion of the air-fuel mixture flows into the filter 23, the PM is trapped by the filter 23 and is deposited on the filter 23. When the amount of PM deposited on the filter 23 becomes large, the filter 23 will clog. As a result, back pressure will increase and reduced output by the internal combustion engine, fuel economy deterioration, etc. are liable to occur.

On the other hand, if the oxygen is supplied to the filter 23 when the temperature of the filter 23 is high, the PM deposited on the filter 23 will react with oxygen and be burned off. As a result, the amount of PM deposited on the filter 23 would decrease and the filter 23 would be regenerated. This phenomenon is promoted by the following fuel cut control.

In the above-mentioned internal combustion engine, when predetermined conditions are satisfied, fuel cut control for stopping the supply of fuel to the combustion chambers 5 is performed. The predetermined conditions are satisfied when, for example, the amount of depression of the accelerator pedal 46 is zero (that is, the engine load is zero) and the engine speed is equal to or higher than a predetermined speed higher than the speed at the time of idling.

If fuel cut control is performed, air is supplied from the intake passage to the exhaust passage through the cylinders. As a result, air will be supplied to the filter 23, and a large amount of oxygen will flow into the filter 23. As a result, while fuel cut control is being performed, burnoff of PM will be promoted and the amount of PM deposited on the filter 23 will decrease. However, if there are few opportunities for fuel cut control to be performed, the amount of PM deposited will gradually increase and the filter 23 liable to clog.

Therefore, in the present embodiment, when predetermined conditions are satisfied, the filter regeneration part 61 performs regeneration processing for oxidizing and removing PM deposited on the filter 23. By doing so, it is possible to keep the amount of PM deposited on the filter 23 from becoming excessive.

The inventors of the present application took note of the fact that the three-way catalyst is supported on the filter 23 and found that by supplying nitric oxide (NO) to the filter 23, oxidation and removal of PM can be promoted. The principle by which PM is oxidized and removed by NO is as follows.

If the air-fuel ratio of the air-fuel mixture in the internal combustion engine is controlled to be in the neighborhood of the stoichiometric air-fuel ratio, a tiny amount (for example, up to 1%) of the oxygen in the exhaust gas will be supplied to the filter 23. At this time, there is barely any burning of PM from reacting with oxygen, but the tiny amount of oxygen does cause the soot (carbon) in the PM to partially oxidize. As a result, some of the PM on the filter 23 is converted to carbon monoxide (CO) in the gas phase. If NO is supplied to the filter 23 in this state, the NO and CO will react due to the catalytic action of the three-way catalyst on the filter 23, and the following chemical reactions will occur.

CO+2NO═N₂O+CO₂ (1)

N₂O+CO═N₂+CO₂ (2)

CO+NO=(1/2)N₂+CO₂ (3)

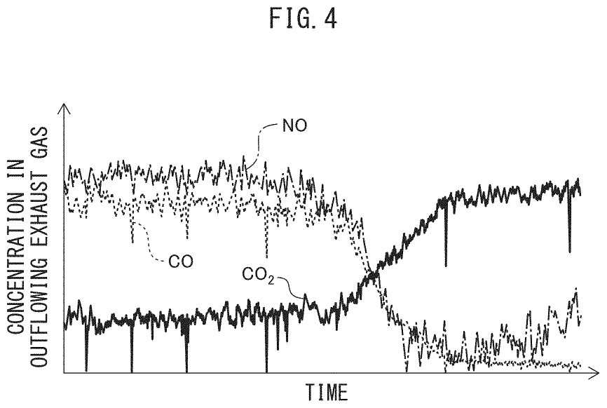

FIG. 4 is a view showing an example of the change over time in the concentrations of NO, CO, and CO₂ in the exhaust gas flowing out from the filter 23 when NO is supplied to the filter 23. As shown in FIG. 4, because of the reactions between NO and CO, the NO concentration (one dot-chain line) and CO concentration (broken line) decrease at the same time, whereas the CO₂ concentration (solid line) rises.

Accordingly, CO is oxidized and converted to CO₂ on the filter 23 by reactions between the NO and the CO. That is, the soot in PM is completely oxidized, and the PM deposited on the filter 23 is oxidized and removed. Further, the heat of reaction from reactions between the NO and the CO causes the temperature of the filter 23 and the three-way catalyst on the filter 23 to rise and the rate of oxidation of PM to rise. Accordingly, by supplying NO to the filter 23, it is possible to promote oxidation reactions when the soot in PM being converted to CO₂ through CO as an intermediate and possible to reduce the amount of PM deposited on the filter 23.

Further, the higher the NO concentration in the exhaust gas flowing into the filter 23 (below, also referred to as the “inflowing exhaust gas”), the more the amount of NO that can react with the CO generated from the PM can be increased. For this reason, when predetermined conditions for performing the regeneration processing are satisfied, the filter regeneration part 61 increases the NO concentration in the inflowing exhaust gas compared to when the predetermined conditions are not satisfied. This makes it possible to promote the reactions between the NO and the CO and possible to further improve oxidation and removal of PM.

Further, in the present embodiment, the filter regeneration part 61 lowers the CO concentration in the inflowing exhaust gas when the predetermined conditions are satisfied compared to when the predetermined conditions are not satisfied. This makes it possible to increase the ratio of the CO generated from the PM relative to the CO in the exhaust gas on the filter 23, that is, the partial pressure of the CO generated from the PM, and possible to promote the reactions between the CO generated from the PM and the NO.

For example, the filter regeneration part 61 controls the air-fuel ratio of the air-fuel mixture supplied to the combustion chambers 5 of the internal combustion engine to a target air-fuel ratio and controls the NO concentration and CO concentration in the inflowing exhaust gas by changing the target air-fuel ratio. Specifically, the filter regeneration part 61 sets the target air-fuel ratio to the stoichiometric air-fuel ratio or to a value richer than the stoichiometric air-fuel ratio when the predetermined conditions are not satisfied and sets the target air-fuel ratio to a value leaner than the stoichiometric air-fuel ratio when the predetermined conditions are satisfied. Due to this, it is possible to increase the NO concentration and reduce the CO concentration in the exhaust gas being discharged into the exhaust passage when the regeneration processing is being performed and, in turn, increase the NO concentration and reduce the CO concentration in the inflowing exhaust gas.

However, if the NO concentration in the exhaust gas is made to increase, the NOx removing performance of the catalyst 20 and the three-way catalyst on the filter 23 will drop. For this reason, if frequently performing the above-mentioned regeneration processing, the exhaust emissions will worsen.

As opposed to this, in the present embodiment, the predetermined conditions for performing the regeneration processing include that the amount of PM deposited on the filter 23 be equal to or greater than a predetermined starting threshold. By doing this, regeneration processing is performed when removal of PM is necessary, and therefore it is possible to keep exhaust emissions from worsening due to regeneration processing.

Further, reactions between the NO and the CO by the three-way catalyst on the filter 23 prominently occur in a predetermined temperature range. For this reason, in the present embodiment, the predetermined conditions for performing the regeneration processing include that the temperature of the three-way catalyst on the filter 23 be within the predetermined range. Due to this, it is possible to promote oxidation and removal of PM and possible to shorten the execution time of the regeneration processing.

Further, when the degree of deterioration of the three-way catalyst on the filter 23 is low, the reactivity of the oxidation reaction of CO on the noble metal of the catalyst will be high, and therefore there is low need to increase the NO concentration in the inflowing exhaust gas to promote the reactions between the NO and the CO. For this reason, in the present embodiment, the predetermined conditions for performing the regeneration processing include that the degree of deterioration of the three-way catalyst on the filter 23 be equal to or greater than a predetermined value. Due to this, the NO concentration in the inflowing exhaust gas is made to increase only when the catalytic action of the three-way catalyst on the filter 23 is reduced, therefore it is possible to keep the exhaust emissions from worsening due to regeneration processing.

Accordingly, in the present embodiment, the predetermined conditions are satisfied and regeneration processing is demanded if the amount of PM deposited on the filter 23 is equal to or greater than the predetermined starting threshold, the temperature of the three-way catalyst on the filter 23 is within the predetermined range, and the degree of deterioration of the three-way catalyst on the filter 23 is equal to greater than the predetermined value. Further, the filter regeneration part 61 starts regeneration processing when the amount of PM deposited on the filter 23 is equal to greater than the starting threshold and ends regeneration processing when the amount of PM deposited on the filter 23 is equal to or less than an ending threshold less than the starting threshold.

<Regeneration Processing>

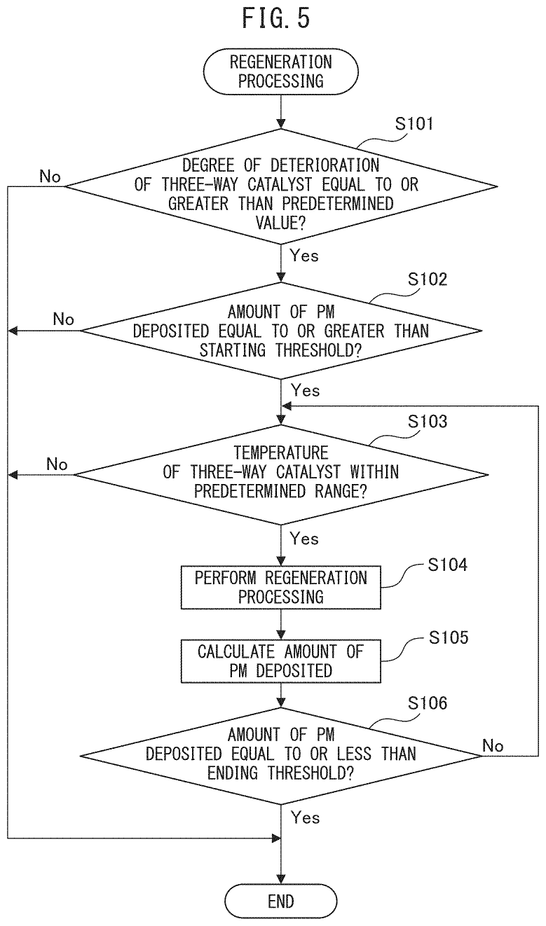

Below, referring to the flow chart of FIG. 5, the control process for oxidizing and removing PM on the filter 23 by the regeneration processing will be explained in detail. FIG. 5 is a flow chart showing a control routine for the regeneration processing in the first embodiment of the present disclosure. The present control routine is repeatedly performed by the ECU 31.

First, at step S101, the filter regeneration part 61 acquires the degree of deterioration of the three-way catalyst on the filter 23 calculated by the deterioration estimating part 64 and judges whether the degree of deterioration is equal to or greater than a predetermined value. The predetermined value is determined in advance by experiments and the like.

For example, the deterioration estimating part 64 calculates the maximum oxygen storage amount of the three-way catalyst on the filter 23 using a known technique that uses the second air-fuel ratio sensor 42 and the third air-fuel ratio sensor 43 arranged before and after the filter 23, and calculates the degree of deterioration of the three-way catalyst on the filter 23 based on the maximum oxygen storage amount. In this case, the smaller the calculated maximum oxygen storage amount, the larger the degree of deterioration of the three-way catalyst on the filter 23. Note that the deterioration estimating part 64 may calculate the degree of deterioration of the three-way catalyst on the filter 23 based on the total travel distance by the vehicle, the cumulative value of the amount of intake air, etc. Further, since deterioration of the three-way catalyst is promoted in a high temperature state like that when PM is burned, the deterioration estimating part 64 may correct the degree of deterioration of the three-way catalyst on the filter 23 based on the temperature of the three-way catalyst on the filter 23 calculated by the temperature calculating part 63.

If it is judged at step S101 that the degree of deterioration of the three-way catalyst on the filter 23 is less than the predetermined value, the present control routine ends. On the other hand, if it is judged at step S101 that the degree of deterioration of the three-way catalyst on the filter 23 is equal to or greater than the predetermined value, the present control routine proceeds to step S102.

At step S102, the filter regeneration part 61 acquires the amount of PM deposited on the filter 23 calculated by the PM calculating part 62 and judges whether the amount of PM deposited is equal to or greater than a predetermined starting threshold. The starting threshold is determined in advance by experiments and the like and is set to, for example, a range between 0.5 g to 5 g, preferably to 1 g.

For example, the PM calculating part 62 calculates the amount of PM deposited based on the output of the differential pressure sensor 44, that is, the differential pressure before and after the filter 23 detected by the differential pressure sensor 44. In this case, the larger the differential pressure before and after the filter 23, the larger the amount of PM deposited.

Further, if the filter 23 is clogged by PM, the pressure in the exhaust passage at the upstream side from the filter 23 increases. As a result, the larger the amount of PM deposited, the larger the differential pressure between the pressure inside the exhaust passage at the upstream side from the filter 23 and atmospheric pressure. For this reason, the differential pressure sensor 44 may be arranged on the upstream side from the filter 23 so as to detect the differential pressure between the pressure inside the exhaust passage at the upstream side from the filter 23 and the atmospheric pressure, and the amount of PM deposited may be calculated based on this differential pressure.

Further, the PM calculating part 62 may calculate the amount of PM deposited based on the history (past values) of the operating state of the internal combustion engine (for example, engine speed, engine load, engine water temperature, etc.) Note that, when PM is burned off by fuel cut control, the PM calculating part 62 reduces the amount of PM deposited according to the execution time of the fuel cut control and the like.

If it is judged at step S102 that the amount of PM deposited is less than the starting threshold, the present control routine ends. On the other hand, if it is judged at step S102 that the amount of PM deposited is equal to or greater than the starting threshold, the present control routine proceeds to step S103.

At step S103, the filter regeneration part 61 acquires the temperature of the three-way catalyst on the filter 23 calculated by the temperature calculating part 63 and judges whether the temperature of the three-way catalyst on the filter 23 is within a predetermined range. The predetermined range is set to a temperature region lower than a temperature region in which a combustion reaction of PM with oxygen is promoted, that is, a temperature region lower than the temperature region at which PM is burned off through fuel cut control (for example, equal to or greater than 500° C.), for example, a temperature region from 250° C. to 500° C., a temperature region from 300° C. to 500° C., etc.

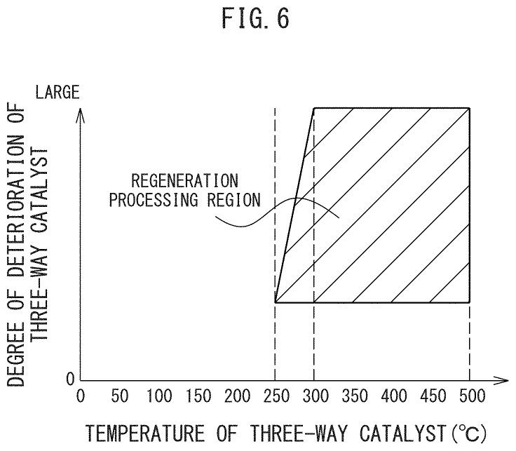

Note that the smaller the degree of deterioration of the three-way catalyst on the filter 23, the lower the minimum temperature at which reactions of NO and CO occur. For this reason, the lower limit of the predetermined range may be changed according to the degree of deterioration of the three-way catalyst on the filter 23. In FIG. 6, the region at which regeneration processing is performed (regeneration processing region) is indicated by hatching. In the example in FIG. 6, the lower limit of the predetermined range is changed between 250° C. and 300° C. depending on the degree of deterioration of the three-way catalyst.

For example, the temperature calculating part 63 calculates the temperature of the three-way catalyst on the filter 23 based on the output of the temperature sensor 45, that is, the temperature of the inflowing exhaust gas detected by the temperature sensor 45. Note that the temperature sensor 45 may be arranged in the exhaust passage at the downstream side from the filter 23 so as to detect the temperature of exhaust gas flowing out from the filter 23 (below, also referred to as the “outflowing exhaust gas”) or arranged on the filter 23 so as to directly detect the temperatures of the filter 23 and the three-way catalyst. Further, the temperature calculating part 63 may calculate the temperature of the three-way catalyst on the filter 23 based on the operating state of the internal combustion engine (for example, engine speed, engine load, ignition timing, etc.).

If it is judged at step S103 that the temperature of the three-way catalyst is outside the predetermined range, the present control routine ends. On the other hand, if it is judged at step S103 that the temperature of the three-way catalyst is within the predetermined range, the present control routine proceeds to step S104.

In this case, regeneration processing is demanded, and, at step S104, the filter regeneration part 61 performs regeneration processing. Specifically, the filter regeneration part 61 sets the target air-fuel ratio of the air-fuel mixture supplied to the combustion chambers 5 of the internal combustion engine to a lean set air-fuel ratio leaner than the stoichiometric air-fuel ratio and controls the amount of fuel supplied to the combustion chambers 5 by the fuel injectors 11 so that the air-fuel ratio of the air-fuel mixture matches the target air-fuel ratio.

For example, the filter regeneration part 61 controls the amount of fuel supplied to the combustion chambers 5 by feedback so that the air-fuel ratio detected by the first air-fuel ratio sensor 41 matches the target air-fuel ratio. Note that the first air-fuel ratio sensor 41 may be omitted, and the filter regeneration part 61 may supply an amount of fuel calculated from the amount of intake air detected by the air flow meter 40 and the target air-fuel ratio to the combustion chambers 5 so that the ratio between fuel and air supplied to the combustion chambers 5 matches the target air-fuel ratio.

At step S104, the lean set air-fuel ratio set as the target air-fuel ratio is determined in advance and set to an air-fuel ratio slightly leaner than the stoichiometric air-fuel ratio (14.6), for example, 14.7 to 14.8. Due to this, it is possible to secure the amount of NO necessary for reactions with CO generated from the PM while keeping exhaust emissions from worsening by the regeneration processing.

Note that, if the target air-fuel ratio for when the regeneration processing is not performed is set to a value leaner than the stoichiometric air-fuel ratio, the filter regeneration part 61 may increase the lean degree of the target air-fuel ratio when performing the regeneration processing. In the present description, the “lean degree” means the difference between an air-fuel ratio leaner than the stoichiometric air-fuel ratio and the stoichiometric air-fuel ratio.

Next, at step S105, the filter regeneration part 61 calculates the amount of PM deposited following the regeneration processing at step S104. For example, the filter regeneration part 61 calculates the amount of PM deposited based on the output of the differential pressure sensor 44 like at step S102.

Note that the filter regeneration part 61 may calculate the amount of PM deposited following the regeneration processing by calculating the amount of PM oxidized and removed by the regeneration processing at step S104 and subtracting that amount from the amount of PM deposited before the regeneration processing. In this case, the filter regeneration part 61 calculates the amount of PM burned off based on, for example, the air-fuel ratio of the inflowing exhaust gas detected by the second air-fuel ratio sensor 42, the temperature of the three-way catalyst on the filter 23 calculated by the temperature calculating part 63, etc.

Next, at step S106, the filter regeneration part 61 judges whether the amount of PM deposited is equal to or less than a predetermined ending threshold. The ending threshold is determined in advance and set to a value less than the starting threshold. Note that the ending threshold may be set to 0 g.

If it is judged at step S106 that the amount of PM deposited is larger than the ending threshold, the present control routine returns to step S103, and step S103 is performed again. On the other hand, if it is judged at step S106 that the amount of PM deposited is equal to or less than the ending threshold, the regeneration processing ends and the present control routine ends.

Note that at least one of steps S101 and S103 or both steps S101 and S102 may be omitted. Further, steps S101 to S103 may be omitted and the regeneration processing may be performed periodically or once each time the internal combustion engine is started.

### Second Embodiment

The exhaust purification system according to a second embodiment is essentially similar to the exhaust purification system in the first embodiment in configuration and control except for the points explained below. For this reason, the parts of the second embodiment of the present disclosure different from the first embodiment will be focused on in the explanation below.

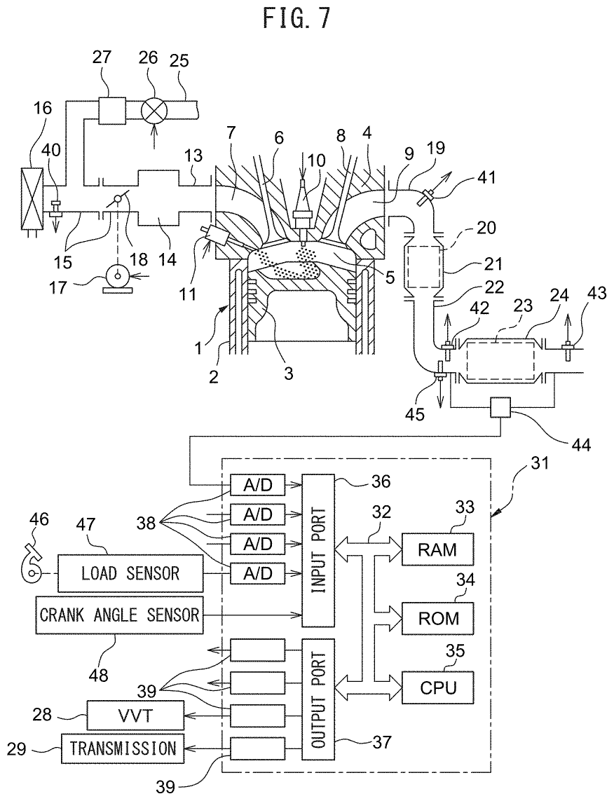

FIG. 7 is a view schematically showing an internal combustion engine in which an exhaust purification system of an internal combustion engine according to the second embodiment of the present disclosure is provided. In the second embodiment, the internal combustion engine is provided with an EGR system for recirculating a portion of the exhaust gas discharged to the exhaust passage to the intake passage as EGR gas. The EGR system is provided with an EGR passage 25, an EGR control valve 26, and an EGR cooler 27.

The EGR passage 25 is connected to the intake passage and exhaust passage and provides communication therebetween. In the present embodiment, the EGR passage 25 is connected to the intake passage at the upstream side from the throttle valve 18 and to the exhaust passage at the downstream side from the filter 23. Note that the EGR passage 25 may be connected to other positions of the intake passage and exhaust passage (for example, the intake manifold 13 and the exhaust manifold 19).

The EGR control valve 26 is arranged in the EGR passage 25 and changes the opening area of the EGR passage 25 according to its opening degree. The EGR cooler 27 is arranged in the EGR passage 25 at the downstream side from the EGR control valve 26 in the EGR gas flow direction and cools EGR gas.

The output port 37 of the ECU 31 is connected through a corresponding drive circuit 39 to the EGR control valve 26 (specifically, the drive motor of the EGR control valve 26), and the ECU 31 controls the EGR control valve 26. Specifically, the ECU 31 controls the opening degree of the EGR control valve 26 and controls the amount of EGR gas being recirculated from the exhaust passage to the intake passage.

Further, in the second embodiment, the output port 37 of the ECU 31 is connected through a corresponding drive circuit 39 to a variable valve timing mechanism (VVT) 28 capable of varying the opening and closing timings of at least one of the intake valve 6 and the exhaust valve 8, and the ECU 31 controls the VVT 28. Specifically, the ECU 31 controls the opening and closing timings of at least one of the intake valve 6 and exhaust valve 8 through the VVT 28.

Further, in the second embodiment, the output port 37 of the ECU 31 is connected through a corresponding drive circuit 39 to a transmission 29 capable of varying the speed ratio of the vehicle, and the ECU 31 controls the transmission 29. Specifically, the ECU 31 controls the speed ratio of the vehicle through the transmission 29.

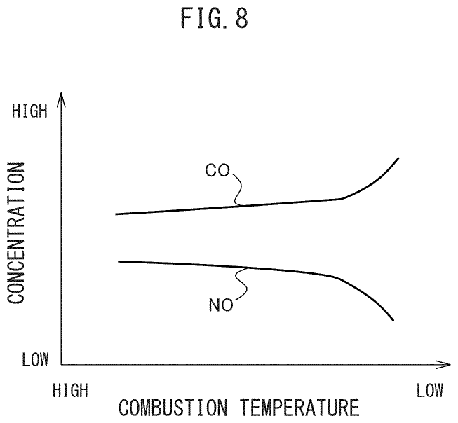

FIG. 8 is a view showing relationships between the combustion temperature of the air-fuel mixture and the NO concentration and CO concentration in exhaust gas. As shown in FIG. 8, the higher the combustion temperature of the air-fuel mixture, the higher the NO concentration in the exhaust gas and the lower the CO concentration in the exhaust gas.

As explained above, the filter regeneration part 61 performs regeneration processing when the predetermined conditions are satisfied, and increases the NO concentration in the inflowing exhaust gas and decreases the CO concentration in the inflowing exhaust gas when the predetermined conditions are satisfied compared to when the predetermined conditions are not satisfied. As a specific method for this, in the second embodiment, focusing on the relationships shown in FIG. 8, the filter regeneration part 61 increases the combustion temperature of the air-fuel mixture supplied to the combustion chambers 5 of the internal combustion engine when the predetermined conditions are satisfied compared to when the predetermined conditions are not satisfied. Due to this, it is possible to increase the NO concentration and reduce the CO concentration in exhaust gas discharged to the exhaust passage when the predetermined conditions are satisfied and regeneration processing is performed and, in turn, increase the NO concentration and reduce the CO concentration in the inflowing exhaust gas.

For example, the filter regeneration part 61 reduces at least one of the external EGR rate and the internal EGR rate when the predetermined conditions are satisfied compared to when the predetermined conditions are not satisfied. Due to this, it is possible to reduce the ratio of inert gas in the combustion chambers 5 and, in turn, increase the combustion temperature of the air-fuel mixture. Note that the “external EGR rate” means the ratio of the amount of EGR gas to the total amount of gas supplied to the combustion chambers 5, while the “internal EGR rate” means the ratio the residual gas (amount of burned gas) to the total amount of gas supplied to the combustion chambers 5.

When reducing the external EGR rate, the filter regeneration part 61 reduces the opening degree of the EGR control valve 26 and reduces the amount of EGR gas being recirculated from the exhaust passage to the intake passage. On the other hand, when reducing the internal EGR rate, the filter regeneration part 61 reduces the valve overlap amount (the period (crank angle) in which both the intake valve 6 and exhaust valve 8 are open) by the VVT 28.

Further, the filter regeneration part 61 may lower the speed ratio of the vehicle by the transmission 29 when the predetermined conditions are satisfied compared to when the predetermined conditions are not satisfied. For example, if the transmission 29 is a multi-speed transmission, the filter regeneration part 61 increases the gear speed (for example, changes the gear speed from third gear to fourth gear) when the predetermined conditions are satisfied. Due to this, the engine load and the amount of intake air increase, resulting in an increase in the combustion temperature of the air-fuel mixture.

Further, if the internal combustion engine is provided with an alcohol supplying system so that alcohol is supplied to the combustion chambers 5 as fuel in addition to gasoline like as described in Japanese Unexamined Patent Publication No. 2014-20262 and the like, the filter regeneration part 61 may reduce the ratio of alcohol to gasoline in the fuel supplied to the combustion chambers 5 when the predetermined conditions are satisfied compared to when the predetermined conditions are not satisfied. Due to this, it is possible to reduce the specific heat of combustion gas and, in turn, increase the combustion temperature of the air-fuel mixture.

In the second embodiment, the control routine for the regeneration processing in FIG. 5 is performed in a similar manner to that in the first embodiment, but at step S104, the filter regeneration part 61 increases the combustion temperature of the air-fuel mixture, instead of changing the target air-fuel ratio, using any of the above-mentioned techniques when performing the regeneration processing.

### Third Embodiment

The exhaust purification system according to a third embodiment is essentially similar to the exhaust purification system in the first embodiment in configuration and control except for the points explained below. For this reason, the parts of the third embodiment of the present disclosure different from the first embodiment will be focused on in the explanation below.

As explained above, the reactions between the CO generated from PM deposited on the filter 23 and the NO supplied to the filter 23 are promoted by the catalytic action of the three-way catalyst on the filter 23. However, if deterioration of the three-way catalyst progresses, the surface area of the noble metal of the three-way catalyst will decrease, reducing the catalytic action of the three-way catalyst. This would result in suppressed reactions between the NO and the CO and a reduced amount of PM oxidized and removed during the regeneration processing.

Therefore, in the third embodiment, as the degree of deterioration of the three-way catalyst on the filter 23 increases, the filter regeneration part 61 increases the NO concentration in the exhaust gas flowing into the filter 23 when performing the regeneration processing and reduces the CO concentration in the exhaust gas flowing into the filter 23 when performing the regeneration processing. Due to this, it is possible to promote reactions between the NO and the CO according to the degree of deterioration of the three-way catalyst and cancel out the reduction in reactivity caused by deterioration of the three-way catalyst. Accordingly, it is possible to keep the execution time of the regeneration processing from being longer and, in turn, keep the exhaust emissions from worsening by the regeneration processing.

For example, as the degree of deterioration of the three-way catalyst on the filter 23 increases, the filter regeneration part 61 increases the lean degree of the target air-fuel ratio of the air-fuel mixture when performing the regeneration processing. Due to this, it is possible to increase the NO concentration and reduce the CO concentration in the exhaust gas being discharged to the exhaust passage as the degree of deterioration of the three-way catalyst increases and, in turn, increase the NO concentration and reduce the CO concentration in the inflowing exhaust gas.

<Regeneration Processing>

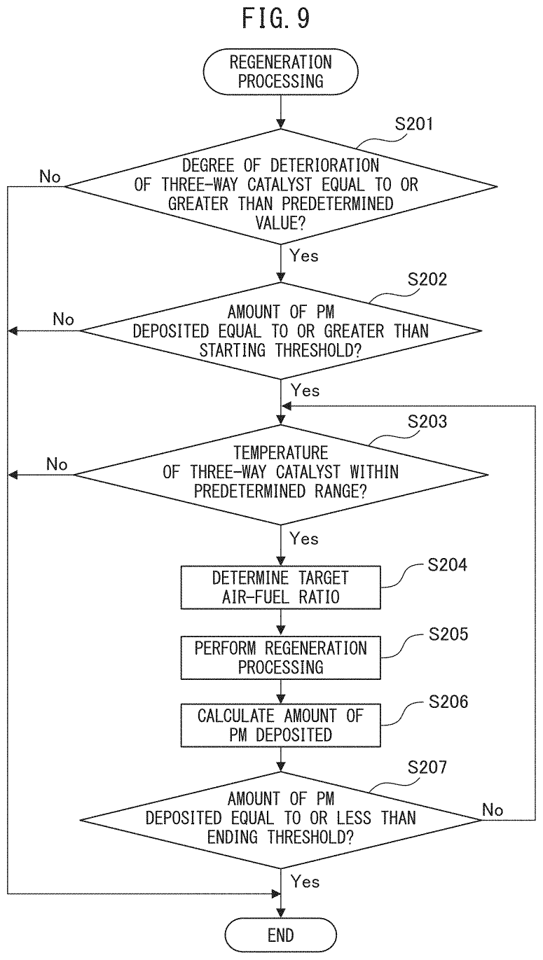

FIG. 9 is a flow chart showing a control routine for the regeneration processing in the third embodiment of the present disclosure. The present control routine is repeatedly performed by the ECU 31.

Steps S201 to step S203 are performed in a similar manner to that of steps S101 to S103 of FIG. 5. If it is judged at step S203 that the temperature of the three-way catalyst on the filter 23 is within the predetermined range, the present control routine proceeds to step S204.

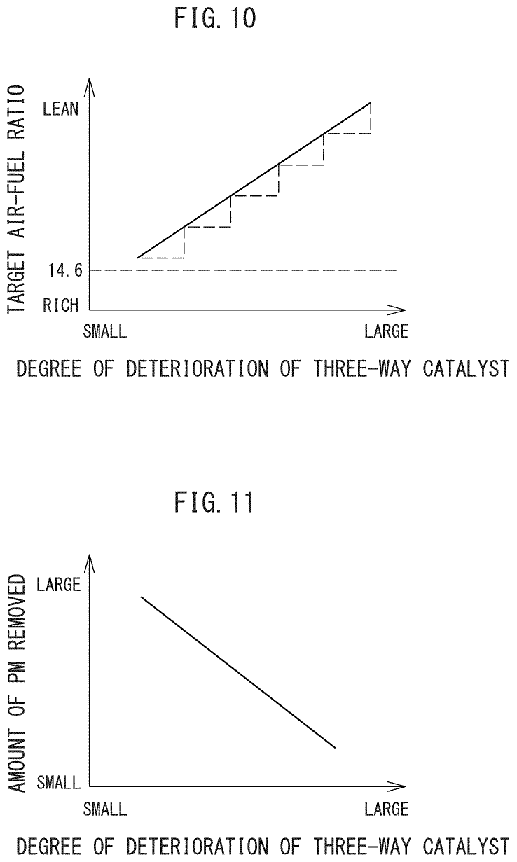

At step S204, the filter regeneration part 61 determines the target air-fuel ratio of the air-fuel mixture supplied to the combustion chambers 5 of the internal combustion engine based on the degree of deterioration of the three-way catalyst on the filter 23 calculated by the deterioration estimating part 64. Specifically, as shown by the solid line in FIG. 10, the filter regeneration part 61 linearly increases the lean degree of the target air-fuel ratio as the degree of deterioration of the three-way catalyst on the filter 23 increases. Note that, as shown by the broken line in FIG. 10, the filter regeneration part 61 may increase the lean degree of the target air-fuel ratio gradually (in steps) as the degree of deterioration of the three-way catalyst on the filter 23 increases.

Next, at step S205, the filter regeneration part 61 performs regeneration processing and sets the target air-fuel ratio of the air-fuel mixture to the target air-fuel ratio determined at step S204. After step S205, step S206 and step S207 are performed in a similar manner to that of step S105 and step S106 of FIG. 5.

### Fourth Embodiment

The exhaust purification system according to a fourth embodiment is essentially similar to the exhaust purification system in the first embodiment in configuration and control except for the points explained below. For this reason, the parts of the fourth embodiment of the present disclosure different from the first embodiment will be focused on in the explanation below.

As explained above, if deterioration of the three-way catalyst on the filter 23 progresses, the amount of PM oxidized and removed during the regeneration processing would be reduced. For this reason, in the fourth embodiment, the PM calculating part 62 calculates the amount of PM oxidized and removed per unit time by the regeneration processing and outputs an amount of PM that is oxidized and removed that is smaller the larger the degree of deterioration of the three-way catalyst on the filter 23. Due to this, it is possible to keep the amount of PM deposited at the end of the regeneration processing from becoming greater than the desired value due to the estimate of the amount of PM removed by the regeneration processing being larger than the desired value. Further, it is possible to keep the execution time of the regeneration processing from becoming excessive and exhaust emissions from worsening due to the estimate of the amount of PM removed by the regeneration processing being smaller than the actual value.

In the fourth embodiment, the control routine for the regeneration processing in FIG. 5 is performed in a similar manner to that in the first embodiment, but at step S105, the PM calculating part 62 calculates the amount of PM oxidized and removed by the regeneration processing (amount of PM removed) based on the degree of deterioration of the three-way catalyst on the filter 23 calculated by the deterioration estimating part 64, and subtracts that amount to calculate the amount of PM deposited following the regeneration processing. At this time, the PM calculating part 62, as shown in FIG. 11, reduces the amount of PM removed the larger the degree of deterioration of the three-way catalyst on the filter 23.

### Fifth Embodiment

The exhaust purification system according to a fifth embodiment is essentially similar to the exhaust purification system in the first embodiment in configuration and control except for the points explained below. For this reason, the parts of the fifth embodiment of the present disclosure different from the first embodiment will be focused on in the explanation below.

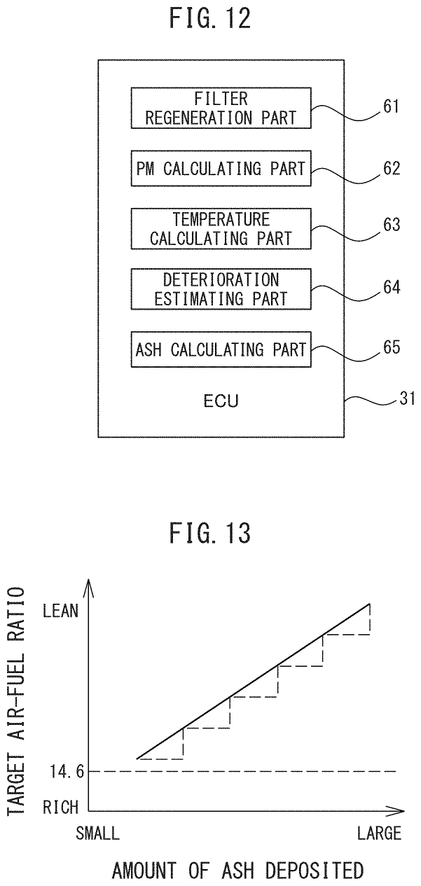

FIG. 12 is a block diagram of the ECU 31 in the fifth embodiment. In the fifth embodiment, the ECU 31 has an ash calculating part 65, in addition to the filter regeneration part 61, the PM calculating part 62, the temperature calculating part 63, and the deterioration estimating part 64. The filter regeneration part 61, the PM calculating part 62, the temperature calculating part 63, the deterioration estimating part 64, and the ash calculating part 65 are functional modules realized by the CPU 35 of the ECU 31 running programs stored in the ROM 34 of the ECU 31.

The ash calculating part 65 calculates the amount of ash deposited on the filter 23. As explained above, reactions between the CO generated from the PM deposited on the filter 23 and the NO supplied to the filter 23 are promoted by the catalytic action of the three-way catalyst on the filter 23. However, if ash originating from engine oil or the like is deposited on the wall of the filter 23, the PM will be trapped on the ash, reducing contact between the three-way catalyst on the filter 23 and PM. This would result in suppressed reactions between the NO and the CO and a reduced amount of PM oxidized and removed during the regeneration processing.

Therefore, in the fifth embodiment, as the amount of ash deposited on the filter 23 increases, the filter regeneration part 61 increases the NO concentration in the inflowing exhaust gas when performing the regeneration processing and reduces the CO concentration in the inflowing exhaust gas when performing the regeneration processing. Due to this, it is possible to promote reactions between the NO and the CO according to the amount of ash deposited and cancel out the reduction in reactivity caused by ash being deposited. For this reason, it is possible to keep the execution time of the regeneration processing from being long and, in turn, keep exhaust emissions from worsening by the regeneration processing.

For example, as the amount of ash deposited on the filter 23 increases, the filter regeneration part 61 increases the lean degree of the target air-fuel ratio of the air-fuel mixture when performing the regeneration processing. Due to this, it is possible to increase the NO concentration and reduce the CO concentration in the exhaust gas being discharged to the exhaust passage as the amount of ash deposited increases and, in turn, increase the NO concentration and reduce the CO concentration in the inflowing exhaust gas.

In the fifth embodiment, the control routine for the regeneration processing in FIG. 9 is performed in a similar manner to that of the third embodiment, but at step S204, the filter regeneration part 61 acquires the amount of ash deposited on the filter 23 calculated by the ash calculating part 65 and determines the target air-fuel ratio of the air-fuel mixture supplied to the combustion chambers 5 of the internal combustion engine based on the amount of ash deposited on the filter 23. Specifically, as shown by the solid line in FIG. 13, the filter regeneration part 61 linearly increases the lean degree of the target air-fuel ratio as the amount of ash deposited increases. Note that, as shown by the broken line in FIG. 13, the filter regeneration part 61 may increase the lean degree of the target air-fuel ratio gradually (in steps) as the amount of ash deposited increases.

For example, the ash calculating part 65 calculates the amount of ash deposited on the filter 23 based on the total travel distance by the vehicle, the cumulative value of the amount of intake air, etc. Note that, not only PM deposition, but ash deposition also causes an increase in back pressure. For this reason, the ash calculating part 65 may calculate the amount of ash deposited on the filter 23 based on the differential pressure before and after the filter 23 or differential pressure between the pressure inside the exhaust passage at the upstream side from the filter 23 and atmospheric pressure detected by the differential pressure sensor 44 when the amount of PM deposited calculated by the PM calculating part 62 is zero.

### Sixth Embodiment

The exhaust purification system according to a sixth embodiment is essentially similar to the exhaust purification system in the first embodiment in configuration and control except for the points explained below. For this reason, the parts of the sixth embodiment of the present disclosure different from the first embodiment will be focused on in the explanation below.

In the sixth embodiment, in the same way as the fifth embodiment, the ECU 31 has an ash calculating part 65 for calculating the amount of ash deposited on the filter 23. As explained above, if ash is deposited on the filter 23, the amount of PM oxidized and removed during the regeneration processing would be reduced. For this reason, in the sixth embodiment, the PM calculating part 62 calculates the amount of PM oxidized and removed per unit time by the regeneration processing and outputs an amount of PM oxidized and removed that is smaller the larger the amount of ash deposited on the filter 23. Due to this, it is possible to keep the amount of PM deposited at the end of the regeneration processing from becoming greater than the desired value due to the estimate of the amount of PM removed by the regeneration processing being larger than the actual value. Further, it is possible to keep the duration of the regeneration processing from becoming excessive and exhaust emissions from worsening due to the estimate of the amount of PM removed by the regeneration processing being smaller than the actual value.

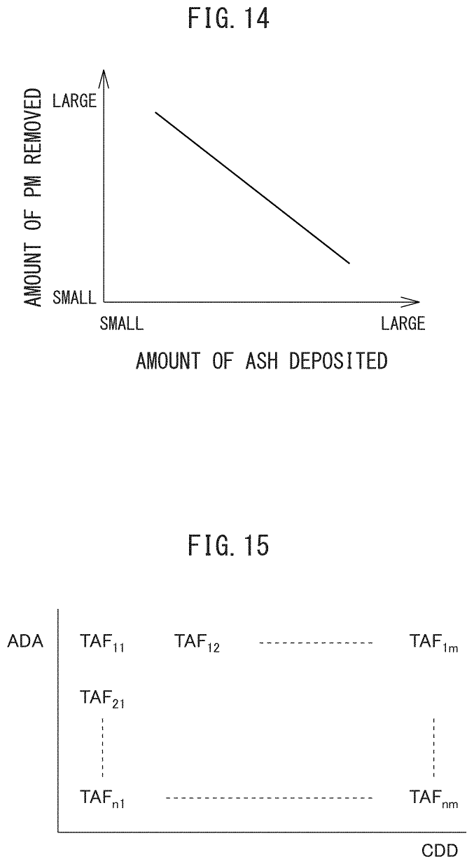

In the sixth embodiment, the control routine for the regeneration processing in FIG. 5 is performed in a similar manner to that of the first embodiment, but at step S105, the PM calculating part 62 calculates the amount of PM oxidized and removed by the regeneration processing (amount of PM removed) based on the amount of ash deposited on the filter 23 calculated by the ash calculating part 65 and subtracts that amount to calculate the amount of PM deposited following the regeneration processing. At this time, the PM calculating part 62, as shown in FIG. 14, outputs an amount of PM removed that is smaller the larger the amount of ash deposited on the filter 23.

### Seventh Embodiment

The exhaust purification system according to a seventh embodiment is essentially similar to the exhaust purification system in the first embodiment in configuration and control except for the points explained below. For this reason, the parts of the seventh embodiment of the present disclosure different from the first embodiment will be focused on in the explanation below.

In the seventh embodiment, in the same way as the fifth embodiment, the ECU 31 has an ash calculating part 65 for calculating the amount of ash deposited on the filter 23. As explained above, if deterioration of the three-way catalyst on the filter 23 progresses, the amount of PM oxidized and removed during the regeneration processing would be reduced. Further, as explained above, if ash is deposited on the filter 23, the amount of PM oxidized and removed during the regeneration processing would be reduced.

For this reason, in the seventh embodiment, the filter regeneration part 61 determines the NO concentration and the CO concentration in the exhaust gas flowing into the filter 23 when performing the regeneration processing based on the degree of deterioration of the three-way catalyst on the filter 23 and the amount of ash deposited on the filter 23. Due to this, it is possible to keep the execution time of the regeneration processing from being long and, in turn, keep exhaust emissions from worsening by the regeneration processing.

For example, the filter regeneration part 61 determines the target air-fuel ratio of the air-fuel mixture when performing the regeneration processing based on degree of deterioration of the three-way catalyst on the filter 23 and the amount of ash deposited on the filter 23. Due to this, it is possible to control the NO concentration and the CO concentration in the exhaust gas being discharged to the exhaust passage and, in turn, the NO concentration and the CO concentration in the inflowing exhaust gas to the desired values according to the degree of deterioration of the three-way catalyst and the amount of ash deposited.

In the seventh embodiment, the control routine for the regeneration processing in FIG. 9 is performed in a similar manner to that of the third embodiment, but at step S204, the filter regeneration part 61 determines the target air-fuel ratio of the air-fuel mixture supplied to the combustion chambers 5 of the internal combustion engine based on the degree of deterioration of the three-way catalyst on the filter 23 calculated by the deterioration estimating part 64 and the amount of ash deposited on the filter 23 calculated by the ash calculating part 65. For example, the filter regeneration part 61 uses a map like that shown in FIG. 15 to calculate the target air-fuel ratio of the air-fuel mixture TAF based on the degree of deterioration of the three-way catalyst CDD and the amount of ash deposited ADA. This map is created so that the larger the degree of deterioration of the three-way catalyst CDD, the greater the lean degree of the target air-fuel ratio TAF and so that the larger the amount of ash deposited ADA, the greater the lean degree of the target air-fuel ratio TAF.

### Eighth Embodiment

The exhaust purification system according to an eighth embodiment is essentially similar to the exhaust purification system in the first embodiment in configuration and control except for the points explained below. For this reason, the parts of the eighth embodiment of the present disclosure different from the first embodiment will be focused on in the explanation below.

In the eighth embodiment, in the same way as the fifth embodiment, the ECU 31 has an ash calculating part 65 for calculating the amount of ash deposited on the filter 23. As explained above, if deterioration of the three-way catalyst on the filter 23 progresses, the amount of PM oxidized and removed during the regeneration processing would be reduced. Further, as explained above, if ash is deposited on the filter 23, the amount of PM oxidized and removed during the regeneration processing would be reduced.

For this reason, in the eighth embodiment, the PM calculating part 62 calculates the amount of PM oxidized and removed per unit time by the regeneration processing based on the degree of deterioration of the three-way catalyst on the filter 23 and the amount of ash deposited on the filter 23. Due to this, it is possible to keep the amount of PM deposited at the end of the regeneration processing from becoming greater than the desired value due to the estimate of the amount of PM removed by the regeneration processing being larger than the actual value. Further, it is possible to keep the duration of the regeneration processing from becoming excessive and exhaust emissions from worsening due to the estimate of the amount of PM removed by the regeneration processing being smaller than the actual value.

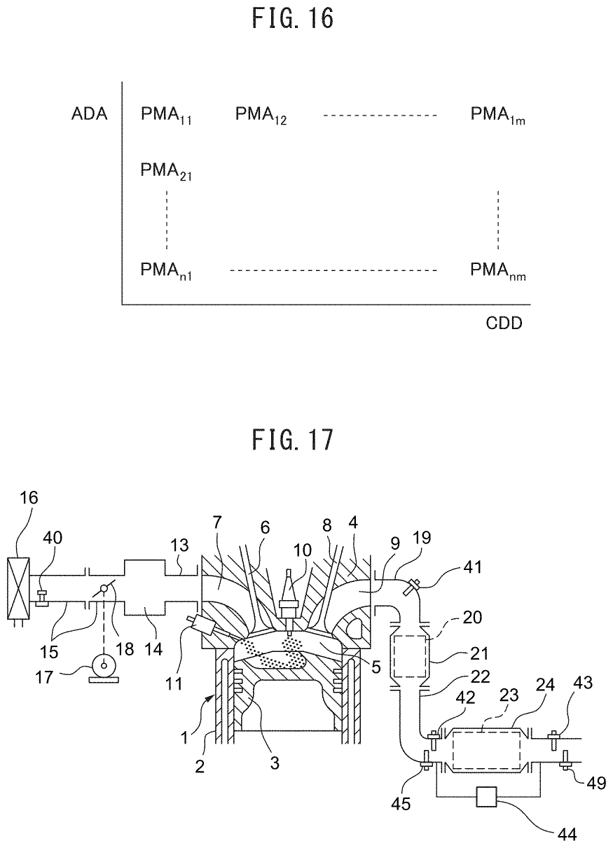

In the eighth embodiment, the control routine for the regeneration processing in FIG. 5 is performed in a similar manner to that of the first embodiment, but at step S105, the PM calculating part 62 calculates the amount of PM oxidized and removed by the regeneration processing (amount of PM removed) based on the degree of deterioration of the three-way catalyst on the filter 23 calculated by the deterioration estimating part 64 and the amount of ash deposited on the filter 23 calculated by the ash calculating part 65 and subtracts that amount to calculate the amount of PM deposited following the regeneration processing. For example, the PM calculating part 62 uses a map like that shown in FIG. 16 to calculate the amount of PM removed PMA based on the degree of deterioration of the three-way catalyst CDD and the amount of ash deposited ADA. This map is created so that the larger the degree of deterioration of the three-way catalyst CDD, the smaller the amount of PM removed PMA, and the larger the amount of ash deposited ADA, the smaller the amount of PM removed PMA.

### Ninth Embodiment

The exhaust purification system according to a ninth embodiment is essentially similar to the exhaust purification system in the first embodiment in configuration and control except for the points explained below. For this reason, the parts of the ninth embodiment of the present disclosure different from the first embodiment will be focused on in the explanation below.

FIG. 17 is a view schematically showing an internal combustion engine in which an exhaust purification system of an internal combustion engine according to the ninth embodiment of the present disclosure is provided. In the ninth embodiment, an exhaust sensor 49 is provided in the internal combustion engine, and the output of the exhaust sensor 49 is input to the ECU 31.

The exhaust sensor 49 is arranged in the exhaust passage at the downstream side from the filter 23, specifically, inside the exhaust pipe 22 at the downstream side from the filter 23. The exhaust sensor 49 detects a concentration of a predetermined component in the outflowing exhaust gas. In the ninth embodiment, the exhaust sensor 49 is an NOx sensor for detecting the NOx concentration in the outflowing exhaust gas. The exhaust sensor 49 is electrically connected to the ECU 31, and the output of the exhaust sensor 49 is input through a corresponding AD converter 38 to the input port 36.

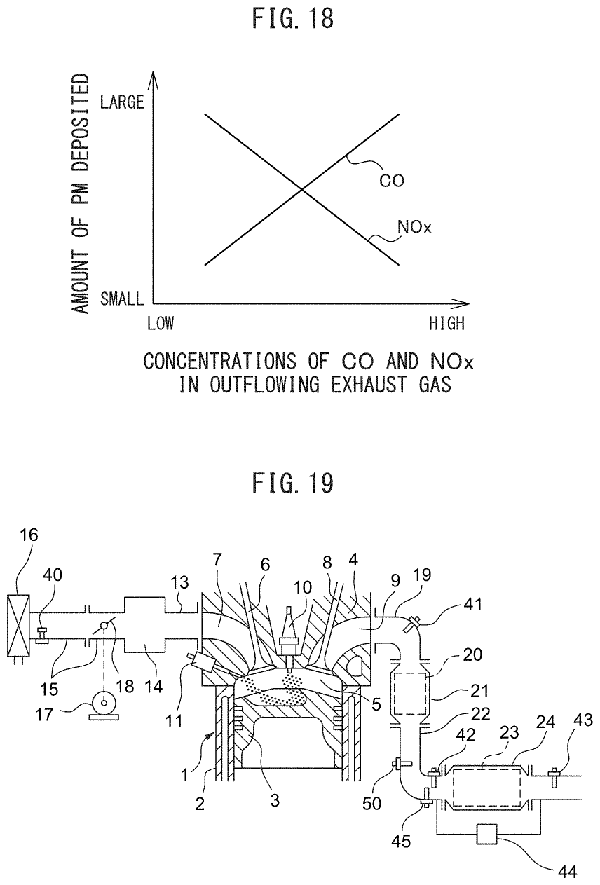

As explained above, when the regeneration processing is being performed, the NO supplied to the filter 23 reacts with the CO generated from the PM. For this reason, the larger the amount of PM deposited on the filter 23, the larger the amount of NO consumed in reactions with CO and the more the NOx concentration in the outflowing exhaust gas falls. Accordingly, the NOx concentration in the outflowing exhaust gas and the amount of PM deposited on the filter 23 have a relationship like that shown in FIG. 18.

Therefore, in the ninth embodiment, the PM calculating part 62 calculates the amount of PM deposited on the filter 23 based on the NOx concentration in the exhaust gas flowing out from the filter 23 when the regeneration processing is being performed. Due to this, it is possible to keep the amount of PM deposited at the end of the regeneration processing from becoming greater than the desired value due to the estimate of the amount of PM deposited during the regeneration processing being larger than the actual value. Further, it is possible to keep the execution time of the regeneration processing from becoming excessive and exhaust emissions from worsening due to the estimate of the amount of PM deposited during the regeneration processing being smaller than the actual value.

In the ninth embodiment, the control routine for the regeneration processing in FIG. 5 is performed in a similar manner to that of the first embodiment, but at step S105, the PM calculating part 62 calculates the amount of PM deposited based on the NOx concentration in the outflowing exhaust gas detected by the exhaust sensor 49. Specifically, the PM calculating part 62, as shown in FIG. 18, outputs an amount of PM deposited that is smaller the higher the NOx concentration in the outflowing exhaust gas.

### 10th Embodiment

The exhaust purification system according to a 10th embodiment is essentially similar to the exhaust purification system in the ninth embodiment in configuration and control except for the points explained below. For this reason, the parts of the 10th embodiment of the present disclosure different from the ninth embodiment will be focused on in the explanation below.

In the 10th embodiment, in the same way as the fifth embodiment, an exhaust sensor 49 is arranged in the internal combustion engine, and the output of the exhaust sensor 49 is input to the ECU 31. In the 10th embodiment, the exhaust sensor 49 is a CO sensor for detecting the CO concentration in the outflowing exhaust gas.

As explained above, when the regeneration processing is being performed, the heat of reaction from the reactions between the NO and the CO causes the temperature of the filter 23 and the three-way catalyst on the filter 23 to rise and causes the rate of oxidation of PM to rise. For this reason, the larger the amount of PM deposited on the filter 23, the larger the amount of CO generated by partial oxidation of the PM and the more the CO concentration in the outflowing exhaust gas rises. Accordingly, the CO concentration in the outflowing exhaust gas and the amount of PM deposited on the filter 23 have a relationship like that shown in FIG. 18.

Therefore, in the 10th embodiment, the PM calculating part 62 calculates the amount of PM deposited on the filter 23 based on the CO concentration in the exhaust gas flowing out from the filter 23 when the regeneration processing is being performed. Due to this, it is possible to keep the amount of PM deposited at the end of the regeneration processing from becoming greater than the desired value due to the estimate of the amount of PM deposited during the regeneration processing being larger than the actual value. Further, it is possible to keep the execution time of the regeneration processing from becoming excessive and exhaust emissions from worsening due to the estimate of the amount of PM deposited during the regeneration processing being smaller than the actual value.

In the 10th embodiment, the control routine for the regeneration processing in FIG. 5 is performed in a similar manner to that of the first embodiment, but at step S105, the PM calculating part 62 calculates the amount of PM deposited based on the CO concentration in the outflowing exhaust gas detected by the exhaust sensor 49. Specifically, the PM calculating part 62, as shown in FIG. 18, outputs an amount of PM deposited that is larger the higher the CO concentration in the outflowing exhaust gas.

### 11th Embodiment

The exhaust purification system according to an 11th embodiment is essentially similar to the exhaust purification system in the first embodiment in configuration and control except for the points explained below. For this reason, the parts of the 11th embodiment of the present disclosure different from the first embodiment will be focused on in the explanation below.

FIG. 19 is a view schematically showing an internal combustion engine in which an exhaust purification system of an internal combustion engine according to the 11th embodiment of the present disclosure is provided. In the 11th embodiment, an exhaust sensor 50 is arranged in the internal combustion engine, and the output of the exhaust sensor 50 is input to the ECU 31.

The exhaust sensor 50 is arranged in the exhaust passage at the downstream side from the catalyst 20 and the upstream side from the filter 23, specifically inside the exhaust pipe 22 between the catalyst 20 and the filter 23. The exhaust sensor 50 detects the concentration of a predetermined component in the inflowing exhaust gas. In the 11th embodiment, the exhaust sensor 50 is an NOx sensor for detecting the NOx concentration in the inflowing exhaust gas. The exhaust sensor 50 is electrically connected to the ECU 31, and the output of the exhaust sensor 50 is input through a corresponding AD converter 38 to the input port 36.

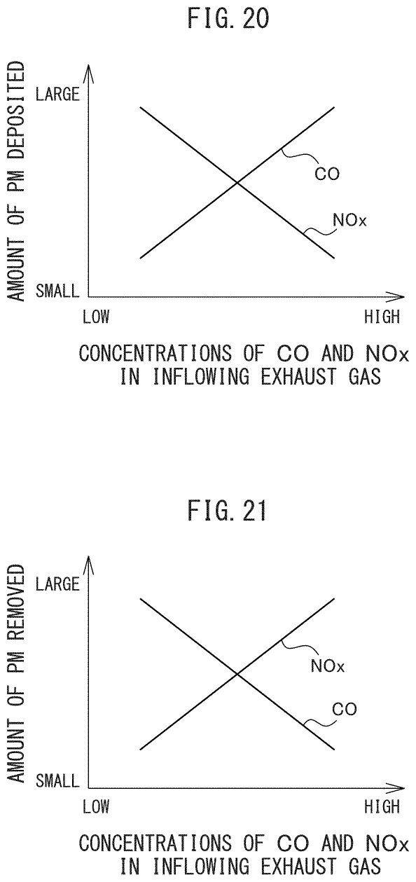

As explained above, when the regeneration processing is being performed, the NO supplied to the filter 23 reacts with the CO generated from the PM. For this reason, the higher the NO concentration in the inflowing exhaust gas, the more reactions between the NO and the CO are promoted and the more the amount of PM deposited following the regeneration processing is reduced. Accordingly, the NOx concentration in the inflowing exhaust gas and the amount of PM deposited on the filter 23 have a relationship like that shown in FIG. 20.

Therefore, in the 11th embodiment, the PM calculating part 62 calculates the amount of PM deposited on the filter 23 based on the NOx concentration in the exhaust gas flowing into the filter 23 when the regeneration processing is being performed. Due to this, it is possible to keep the amount of PM deposited at the end of the regeneration processing from becoming greater than the desired value due to the estimate of the amount of PM deposited during the regeneration processing being larger than the actual value. Further, it is possible to keep the execution time of the regeneration processing from becoming excessive and exhaust emissions from worsening due to the estimate of the amount of PM deposited during the regeneration processing being smaller than the actual value.

In the 11th embodiment, the control routine for the regeneration processing in FIG. 5 is performed in a similar manner to that of the first embodiment, but at step S105, the PM calculating part 62 calculates the amount of PM deposited based on the NOx concentration in the inflowing exhaust gas detected by the exhaust sensor 50. Specifically, the PM calculating part 62, as shown in FIG. 20, outputs an amount of PM deposited that is smaller the higher the NOx concentration in the inflowing exhaust gas.

Note that, at step S105, the PM calculating part 62 may calculate the amount of PM oxidized and removed by the regeneration processing (amount of PM removed) based on the NOx concentration in the inflowing exhaust gas detected by the exhaust sensor 50 and subtract that amount to calculate the amount of PM deposited following the regeneration processing. In this case, the PM calculating part 62, as shown in FIG. 21, outputs an amount of PM removed that is larger the higher the NOx concentration in the inflowing exhaust gas.

### 12th Embodiment

The exhaust purification system according to a 12th embodiment is essentially similar to the exhaust purification system in the 11th embodiment in configuration and control except for the points explained below. For this reason, the parts of the 12th embodiment of the present disclosure different from the 11th embodiment will be focused on in the explanation below.

In the 12th embodiment, in the same way as the 11th embodiment, the exhaust sensor 50 is provided in the internal combustion engine, and the output of the exhaust sensor 50 is input to the ECU 31. In the 12th embodiment, the exhaust sensor 50 is a CO sensor for detecting the CO concentration in the inflowing exhaust gas.

As explained above, the lower the CO concentration in the inflowing exhaust gas, the higher the partial pressure of the CO generated from the PM and the more reactions between the CO generated from the PM and the NO are promoted. For this reason, the lower the CO concentration in the inflowing exhaust gas, the smaller the amount of PM deposited following the regeneration processing. Accordingly, the CO concentration in the inflowing exhaust gas and the amount of PM deposited on the filter 23 have a relationship like that shown in FIG. 20.

Therefore, in the 12th embodiment, the PM calculating part 62 calculates the amount of PM deposited on the filter 23 based on the CO concentration in the exhaust gas flowing into the filter 23 when the regeneration processing is being performed. Due to this, it is possible to keep the amount of PM deposited at the end of the regeneration processing from becoming greater than the desired value due to the estimate of the amount of PM deposited during the regeneration processing being larger than the actual value. Further, it is possible to keep the execution time of the regeneration processing from becoming excessive and exhaust emissions from worsening due to the estimate of the amount of PM deposited during the regeneration processing being smaller than the actual value.

In the 12th embodiment, the control routine for the regeneration processing in FIG. 5 is performed in a similar manner to that of the first embodiment, but at step S105, the PM calculating part 62 calculates the amount of PM deposited based on the CO concentration in the inflowing exhaust gas detected by the exhaust sensor 50. Specifically, the PM calculating part 62, as shown in FIG. 20, outputs an amount of PM deposited that is larger the higher the CO concentration in the inflowing exhaust gas.

Note that, at step S105, the PM calculating part 62 may calculate the amount of PM oxidized and removed by the regeneration processing (amount of PM removed) based on the CO concentration in the inflowing exhaust gas detected by the exhaust sensor 50 and subtract that amount to calculate the amount of PM deposited following the regeneration processing. In this case, the PM calculating part 62, as shown in FIG. 21, outputs an amount of PM removed that is smaller the higher the CO concentration in the inflowing exhaust gas.

### 13th Embodiment

The exhaust purification system according to a 13th embodiment is essentially similar to the exhaust purification system in the first embodiment in configuration and control except for the points explained below. For this reason, the parts of the 13th embodiment of the present disclosure different from the first embodiment will be focused on in the explanation below.

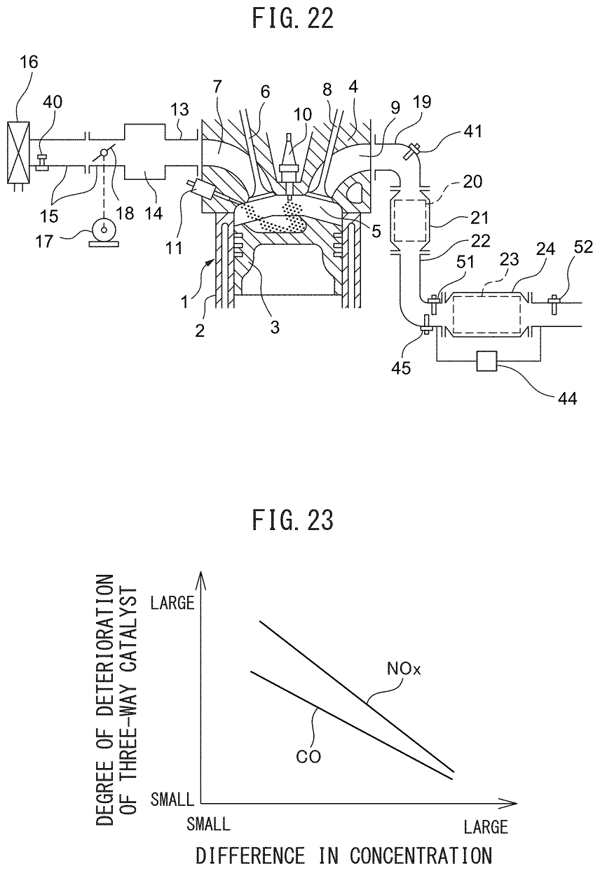

FIG. 22 is a view schematically showing an internal combustion engine in which an exhaust purification system of an internal combustion engine according to the 13th embodiment of the present disclosure is provided. In the 13th embodiment, instead of the second air-fuel ratio sensor 42 and the third air-fuel ratio sensor 43, an upstream side exhaust sensor 51 and a downstream side exhaust sensor 52 are provided in the internal combustion engine, and the outputs of the upstream side exhaust sensor 51 and the downstream side exhaust sensor 52 are input to the ECU 31.

The upstream side exhaust sensor 51 is arranged in the exhaust passage at the downstream side from the catalyst 20 and the upstream side from the filter 23, specifically inside the exhaust pipe 22 between the catalyst 20 and the filter 23. The upstream side exhaust sensor 51 detects the concentration of a predetermined component in the inflowing exhaust gas. In the 13th embodiment, the upstream side exhaust sensor 51 is an NOx sensor for detecting the NOx concentration in the inflowing exhaust gas. The upstream side exhaust sensor 51 is electrically connected to the ECU 31, and the output of the upstream side exhaust sensor 51 is input through a corresponding AD converter 38 to the input port 36.

On the other hand, the downstream side exhaust sensor 52 is arranged in the exhaust passage at the downstream side from the filter 23, specifically inside the exhaust pipe 22 at the downstream side from the filter 23. The downstream side exhaust sensor 52 detects the concentration of a predetermined component in the outflowing exhaust gas. In the 13th embodiment, the downstream side exhaust sensor 52 is an NOx sensor for detecting the NOx concentration in the outflowing exhaust gas. The downstream side exhaust sensor 52 is electrically connected to the ECU 31, and the output of the exhaust sensor 49 is input through a corresponding AD converter 38 to the input port 36.

As explained above, if deterioration of the three-way catalyst on the filter 23 progresses, the catalytic action of the three-way catalyst will be reduced and reactions between the NO and the CO will be suppressed. For this reason, the larger the degree of deterioration of the three-way catalyst on the filter 23, the smaller the amount of NO consumed in reactions with CO and the smaller the difference in the NOx concentration before and after the filter 23. Accordingly, the difference in the NOx concentration before and after the filter 23 and the degree of deterioration of the three-way catalyst on the filter 23 have a relationship like that shown in FIG. 23.

Therefore, in the 13th embodiment, the deterioration estimating part 64 calculates the degree of deterioration of the three-way catalyst on the filter 23 based on the NOx concentration in the exhaust gas flowing into the filter 23 when the regeneration processing is being performed and the NOx concentration in the exhaust gas flowing out from the filter 23 when the regeneration processing is being performed. Due to this, it is possible to oxidize and remove PM by the regeneration processing while estimating the degree of deterioration of the three-way catalyst on the filter 23. Accordingly, an air-fuel ratio control for estimating the degree of deterioration of the three-way catalyst on the filter 23 (for example, control for switching the target air-fuel ratio of the air-fuel mixture between an air-fuel ratio richer than the stoichiometric air-fuel ratio and an air-fuel ratio leaner than the stoichiometric air-fuel ratio) is not necessary, and thus it is possible to keep exhaust emissions from worsening.

<Deterioration Estimation Processing>

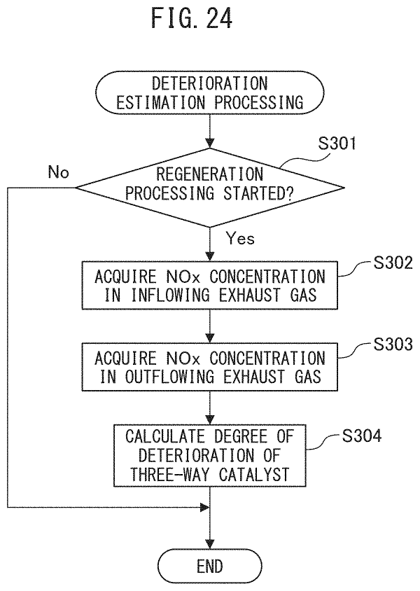

FIG. 24 is a flow chart showing a control routine for deterioration estimation processing in the 13th embodiment of the present disclosure. The present control routine is repeatedly performed by the ECU 31.

First, at step S301, the deterioration estimating part 64 judges whether regeneration processing has been started by the filter regeneration part 61. If it is judged that regeneration processing has not been started, the present control routine ends. On the other hand, if it is judged that regeneration processing has been started, the present control routine proceeds to step S302.

At step S302, the deterioration estimating part 64 acquires the NOx concentration in the inflowing exhaust gas detected by the upstream side exhaust sensor 51. Note that the NOx concentration in the inflowing exhaust gas may be the average of values intermittently detected multiples times during the regeneration processing, the average of values detected within a predetermined time during the regeneration processing, etc.

Next, at step S303, the deterioration estimating part 64 acquires the NOx concentration in the outflowing exhaust gas detected by the downstream side exhaust sensor 52. Note that the NOx concentration in the outflowing exhaust gas may be the average of values intermittently detected multiples times during the regeneration processing, the average of values detected within a predetermined time during the regeneration processing, etc.

Next, at step S304, the deterioration estimating part 64 calculates the degree of deterioration of the three-way catalyst on the filter 23 based on the NOx concentration in the inflowing exhaust gas and the NOx concentration in the outflowing exhaust gas. For example, the deterioration estimating part 64, as shown in FIG. 23, outputs a degree of deterioration of the three-way catalyst on the filter 23 that is smaller the larger the difference between the NOx concentration in the inflowing exhaust gas and the NOx concentration in the outflowing exhaust gas. Note that the deterioration estimating part 64 may output a degree of deterioration of the three-way catalyst on the filter 23 that is smaller the larger the ratio of the NOx concentration in the inflowing exhaust gas to the NOx concentration in the outflowing exhaust gas. After step S304, the present control routine ends.

Further, in the 13th embodiment, the control routine for the regeneration processing in FIG. 5 is performed in a similar manner to that of the first embodiment, but at step S101, the filter regeneration part 61 acquires the degree of deterioration of the three-way catalyst on the filter 23 calculated by the deterioration estimating part 64 as described above when the previous regeneration processing was performed, and judges whether the degree of deterioration is equal to or greater than the predetermined value.

### 14th Embodiment

The exhaust purification system according to a 14th embodiment is essentially similar to the exhaust purification system in the 13th embodiment in configuration and control except for the points explained below. For this reason, the parts of the 14th embodiment of the present disclosure different from the 13th embodiment will be focused on in the explanation below.

In the 14th embodiment, in the same way as the 13th embodiment, an upstream side exhaust sensor 51 and a downstream side exhaust sensor 52 are provided in the internal combustion engine, and the outputs of the upstream side exhaust sensor 51 and the downstream side exhaust sensor 52 are input to the ECU 31. In the 14th embodiment, the upstream side exhaust sensor 51 is a CO sensor for detecting the CO concentration in the inflowing exhaust gas, and the downstream side exhaust sensor 52 is a CO sensor for detecting the CO concentration in the outflowing exhaust gas.

As explained above, if deterioration of the three-way catalyst on the filter 23 progresses, the catalytic action of the three-way catalyst will be reduced and reactions between the NO and the CO will be suppressed. Further, on the three-way catalyst, there will not only be reactions between the CO generated from the PM and the NO, but reactions between the CO in the inflowing exhaust gas and the NO. For this reason, the larger the degree of deterioration of the three-way catalyst on the filter 23, the smaller the amount of CO in the exhaust gas consumed in reactions with NO and the smaller the difference in the CO concentrations before and after the filter 23. Accordingly, the difference in the CO concentrations before and after the filter 23 and the degree of deterioration of the three-way catalyst on the filter 23 have a relationship like that shown in FIG. 23.

Therefore, in the 14th embodiment, the deterioration estimating part 64 calculates the degree of deterioration of the three-way catalyst on the filter 23 based on the CO concentration in the exhaust gas flowing into the filter 23 when the regeneration processing is being performed and the CO concentration in the exhaust gas flowing out from the filter 23 when the regeneration processing is being performed. Due to this, it is possible to oxidize and remove PM by regeneration processing while estimating the degree of deterioration of the three-way catalyst on the filter 23. Accordingly, an air-fuel ratio control for estimating the degree of deterioration of the three-way catalyst on the filter 23 (for example, control for switching the target air-fuel ratio of the air-fuel mixture between an air-fuel ratio richer than the stoichiometric air-fuel ratio and an air-fuel ratio leaner than the stoichiometric air-fuel ratio) is not necessary, and thus it is possible to keep exhaust emissions from worsening.

<Deterioration Estimation Processing>

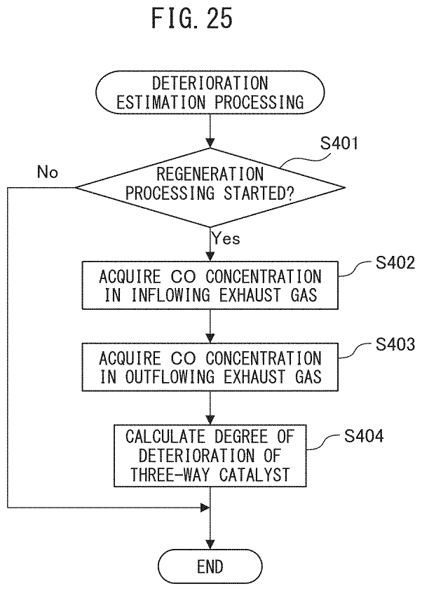

FIG. 25 is a flow chart showing a control routine for deterioration estimation processing in the 14th embodiment of the present disclosure. The present control routine is repeatedly performed by the ECU 31.

First, at step S401, the deterioration estimating part 64 judges whether the regeneration processing has been started by the filter regeneration part 61. If it is judged that the regeneration processing has not been started, the present control routine ends. On the other hand, if it judged that the regeneration processing has been stared, the present control routine proceeds to step S402.

At step S402, the deterioration estimating part 64 acquires the CO concentration in the inflowing exhaust gas detected by the upstream side exhaust sensor 51. Note that the CO concentration in the inflowing exhaust gas may be the average of values intermittently detected multiples times during the regeneration processing, the average of values detected within a predetermined time during the regeneration processing, etc.

Next, at step S403, the deterioration estimating part 64 acquires the CO concentration in the outflowing exhaust gas detected by the downstream side exhaust sensor 52. Note that the CO concentration in the outflowing exhaust gas may be the average of values intermittently detected multiples times during the regeneration processing, the average of values detected within a predetermined time during the regeneration processing, etc.

Next, at step S404, the deterioration estimating part 64 calculates the degree of deterioration of the three-way catalyst on the filter 23 based on the CO concentration in the inflowing exhaust gas and the CO concentration in the outflowing exhaust gas. For example, the deterioration estimating part 64, as shown in FIG. 23, outputs a degree of deterioration of the three-way catalyst on the filter 23 that is smaller the larger the difference between the CO concentration in the inflowing exhaust gas and the CO concentration in the outflowing exhaust gas. Note that the deterioration estimating part 64 may output a degree of deterioration of the three-way catalyst on the filter 23 that is smaller the larger the ratio of the CO concentration in the inflowing exhaust gas to the CO concentration in the outflowing exhaust gas. After step S404, the present control routine ends.

Further, in the 14th embodiment, the control routine for the regeneration processing in FIG. 5 is performed in a similar manner to that of the first embodiment, but at step S101, the filter regeneration part 61 acquires the degree of deterioration of the three-way catalyst on the filter 23 calculated by the deterioration estimating part 64 as described above when the previous regeneration processing was performed, and judges whether the degree of deterioration is equal to or greater than the predetermined value.

Note that, in the 13th embodiment and the 14th embodiment, in the same way as the first embodiment, a second air-fuel ratio sensor 42 and a third air-fuel ratio sensor 43 may be provided in the internal combustion engine.

### Other Embodiments

Above, preferred embodiments according to the present disclosure were explained, but the present disclosure is not limited to these embodiments and can be corrected and changed in various ways within the language of the claims. For example, the filter 23 may be arranged at the upstream side from the catalyst 20. Further, the catalyst 20 may be omitted from the internal combustion engine.

Further, the above embodiments can be carried out in any combination. For example, in the third to 14th embodiments, like in the second embodiment, the filter regeneration part 61 may increase the combustion temperature of the air-fuel mixture supplied to the combustion chambers 5 of the internal combustion engine when the predetermined conditions for performing the regeneration processing are satisfied compared to when the predetermined conditions are not satisfied.

If the second embodiment and the third embodiment are combined, the filter regeneration part 61 increases the combustion temperature of the air-fuel mixture when performing the regeneration processing as the degree of deterioration of the three-way catalyst on the filter 23 increases. For example, the filter regeneration part 61 reduces the opening degree of the EGR control valve 26, reduces the valve overlap amount, reduces the speed ratio of the vehicle, or reduces the ratio of alcohol to gasoline as the degree of deterioration of the three-way catalyst on the filter 23 increases.

If the second embodiment and the fifth embodiment are combined, the filter regeneration part 61 increases the combustion temperature of the air-fuel mixture when performing the regeneration processing as the amount of ash deposited on the filter 23 increases. For example, the filter regeneration part 61 reduces the opening degree of the EGR control valve 26, reduces the valve overlap amount, reduces the speed ratio of the vehicle, or reduces the percentage of alcohol to gasoline as the amount of ash deposited on the filter 23 increases.

If the second embodiment and the seventh embodiment are combined, the filter regeneration part 61 determines the combustion temperature of the air-fuel mixture (target combustion temperature) when performing the regeneration processing based on the degree of deterioration of the three-way catalyst on the filter 23 and the amount of ash deposited on the filter 23.

Further, in the third embodiment, the fifth embodiment, and the seventh embodiment, like in the 9th embodiment, the 10th embodiment, the 11th embodiment, or the 12th embodiment, the PM calculating part 62 may calculate the amount of PM deposited on the filter 23 based on the NOx concentration or the CO concentration in the exhaust gas flowing into the filter 23 when the regeneration processing is being performed or the NOx concentration or the CO concentration in the exhaust gas flowing out from the filter 23 when the regeneration processing is being performed.

Further, in the third to 12th embodiments, like in the 13th embodiment or 14th embodiment, the deterioration estimating part 64 may calculate the degree of deterioration of the three-way catalyst on the filter 23 based on both the NOx concentration in the exhaust gas flowing into the filter 23 when the regeneration processing is being performed and the NOx concentration in the exhaust gas flowing out from the filter 23 when the regeneration processing is being performed, or both the CO concentration in the exhaust gas flowing into the filter 23 when the regeneration processing is being performed and the CO concentration in the exhaust gas flowing out from the filter 23 when the regeneration processing is being performed.

If the third embodiment or the seventh embodiment is combined with the 13th embodiment or the 14th embodiment, at step S204 of FIG. 9, the degree of the deterioration of the three-way catalyst on the filter 23 calculated according to the control routine of the deterioration estimation processing in FIG. 24 or FIG. 25 when the previous regeneration processing was performed is used.

If the fourth or the eighth embodiment is combined with the 13th or the 14th embodiment, at step S105 of FIG. 5, the degree of the deterioration of the three-way catalyst on the filter 23 calculated according to the control routine of the deterioration estimation processing in FIG. 24 or FIG. 25 when the previous regeneration processing was performed is used.

### REFERENCE SIGNS LIST

23. filter

31. electronic control unit (ECU)

61. filter regeneration part

62. PM calculating part

63. temperature calculating part

64. deterioration estimating part

1. An exhaust purification system of an internal combustion engine, comprising:
a filter trapping particulate matter in exhaust gas flowing through an exhaust passage of the internal combustion engine and supporting a three-way catalyst; and
an electronic control unit, wherein
the electronic control unit is configured to perform regeneration processing for oxidizing and removing particulate matter deposited on the filter when predetermined conditions are satisfied, and increase an NO concentration in exhaust gas flowing into the filter when the predetermined conditions are satisfied compared to when the predetermined conditions are not satisfied.

2. The exhaust purification system of the internal combustion engine according to claim 1, wherein
the electronic control unit is configured to calculate a temperature of the three-way catalyst, and
the predetermined conditions include that the temperature of the three-way catalyst be within a predetermined range.

3. The exhaust purification system of the internal combustion engine according to claim 1, wherein
the electronic control unit is configured to calculate a degree of deterioration of the three-way catalyst, and
the predetermined conditions include that the degree of deterioration of the three-way catalyst be equal to or greater than a predetermined value.

4. The exhaust purification system of the internal combustion engine according to claim 1, wherein the electronic control unit is configured to control an air-fuel ratio of an air-fuel mixture supplied to combustion chambers of the internal combustion engine to a target air-fuel ratio, and set the target air-fuel ratio to a value leaner than a stoichiometric air-fuel ratio when the predetermined conditions are satisfied.

5. The exhaust purification system of the internal combustion engine according to claim 1, wherein the electronic control unit is configured to increase a combustion temperature of an air-fuel mixture supplied to the combustion chambers of the internal combustion engine when the predetermined conditions are satisfied compared to when the predetermined conditions are not satisfied.

6. The exhaust purification system of the internal combustion engine according to claim 1, wherein the electronic control unit is configured to calculate a degree of deterioration of the three-way catalyst, and increase the NO concentration in the exhaust gas flowing into the filter when performing the regeneration processing as the degree of deterioration of the three-way catalyst increases.

7. The exhaust purification system of the internal combustion engine according to claim 1, wherein the electronic control unit is configured to calculate an amount of ash deposited on the filter, increase the NO concentration in the exhaust gas flowing into the filter when performing the regeneration processing as the amount of ash deposited increases.

8. The exhaust purification system of the internal combustion engine according to claim 1, wherein the electronic control unit is configured to calculate a degree of deterioration of the three-way catalyst, calculate an amount of ash deposited on the filter, and determine the NO concentration in the exhaust gas flowing into the filter when performing the regeneration processing based on the degree of deterioration of the three-way catalyst and the amount of ash deposited.

9. The exhaust purification system of the internal combustion engine according to claim 1, wherein the electronic control unit is configured to calculate an amount of particulate matter deposited on the filter, calculate a degree of deterioration of the three-way catalyst, start the regeneration processing when the amount of particulate matter deposited is equal to or greater than a predetermined starting threshold, end the regeneration processing when the amount of particulate matter deposited is equal to or less than a predetermined ending threshold, calculate an amount of particulate matter oxidized and removed per unit time by the regeneration processing, and output an amount of particulate matter that is smaller the larger the degree of deterioration of the three-way catalyst.

10. The exhaust purification system of the internal combustion engine according to claim 1, wherein the electronic control unit is configured to calculate an amount of particulate matter deposited on the filter, calculate an amount of ash deposited on the filter, start the regeneration processing when the amount of particulate matter deposited is equal to or greater than a predetermined starting threshold, end the regeneration processing when the amount of particulate matter deposited is equal to or less than a predetermined ending threshold, calculate an amount of particulate matter oxidized and removed per unit time by the regeneration processing, and output an amount of particulate matter that is smaller the larger the amount of ash deposited.

11. The exhaust purification system of the internal combustion engine according to claim 1, wherein the electronic control unit is configured to calculate an amount of particulate matter deposited on the filter, calculate a degree of deterioration of the three-way catalyst, calculate an amount of ash deposited on the filter, start the regeneration processing when the amount of particulate matter deposited is equal to or greater than a predetermined starting threshold, end the regeneration processing when the amount of particulate matter deposited is equal to or less than a predetermined ending threshold, and calculate an amount of particulate matter oxidized and removed per unit time by the regeneration processing based on the degree of deterioration of the three-way catalyst and amount of deposited ash.

12. The exhaust purification system of the internal combustion engine according to claim 1, wherein the electronic control unit is configured to calculate an amount of particulate matter deposited on the filter, and calculate the amount of particulate matter deposited based on a NOx concentration or a CO concentration in exhaust gas flowing out from the filter when the regeneration processing is being performed.

13. The exhaust purification system of the internal combustion engine according to claim 1, wherein the electronic control unit is configured to calculate an amount of particulate matter deposited on the filter, and calculate the amount of particulate matter deposited based on a NOx concentration or a CO concentration in exhaust gas flowing into the filter when the regeneration processing is being performed.

14. The exhaust purification system of the internal combustion engine according to claim 1, wherein the electronic control unit is configured to calculate a degree of deterioration of the three-way catalyst, and calculate the degree of deterioration of the three-way catalyst based on a NOx concentration in exhaust gas flowing into the filter when the regeneration processing is being performed and a NOx concentration in exhaust gas flowing out from the filter when the regeneration processing is being performed.

15. The exhaust purification system of the internal combustion engine according to claim 1, wherein the electronic control unit is configured to calculate a degree of deterioration of the three-way catalyst, and calculate the degree of deterioration of the three-way catalyst based on a CO concentration in exhaust gas flowing into the filter when the regeneration processing is being performed and a CO concentration in exhaust gas flowing out from the filter when the regeneration processing is being performed.

16. An exhaust purification system of an internal combustion engine, comprising:
a filter trapping particulate matter in exhaust gas flowing through an exhaust passage of the internal combustion engine and supporting a three-way catalyst; and
an electronic control unit, wherein
the electronic control unit is configured to perform regeneration processing for oxidizing and removing particulate matter deposited on the filter, calculate an amount of particulate matter deposited on the filter, perform the regeneration processing by supplying NO to the filter, and calculate the amount of particulate matter deposited based on a NOx concentration or a CO concentration in exhaust gas flowing into the filter when the regeneration processing is being performed or a NOx concentration or a CO concentration in exhaust gas flowing out from the filter when the regeneration processing is being performed.

17. An exhaust purification system of an internal combustion engine, comprising:
a filter trapping particulate matter in exhaust gas flowing through an exhaust passage of the internal combustion engine and supporting a three-way catalyst; and
an electronic control unit, wherein
the electronic control unit is configured to perform regeneration processing for oxidizing and removing particulate matter deposited on the filter, calculate a degree of deterioration of the three-way catalyst, perform the regeneration processing by supplying NO to the filter, and calculate the degree of deterioration of the three-way catalyst based on both a NOx concentration in exhaust gas flowing into the filter when the regeneration processing is being performed and a NOx concentration in exhaust gas flowing out from the filter when the regeneration processing is being performed or both a CO concentration in exhaust gas flowing into the filter when the regeneration processing is being performed and a CO concentration in exhaust gas flowing out from the filter when the regeneration processing is being performed.
